(19) United States
(12) Patent Application Publication
(10) Pub. No.: US 2019/0359087 A1
(43) Pub. Date: Nov. 28, 2019

(54) SEAT ASSEMBLY AND CONFIGURATION FOR A VEHICLE INTERIOR

(71) Applicant: Shanghai Yanfeng Jinqiao Automotive Trim Systems Co. Ltd., Novi, MI (US)

(72) Inventors: Jesus Maria Galan Garcia, Düsseldorf (DE); Norbert Truxa, Düsseldorf (DE); Lucas Eyl, Wuppertal (DE); Alexander Butchart, Muenchen (DE)

(21) Appl. No.: 16/331,332

(22) PCT Filed: Sep. 8, 2017
(86) PCT No.: PCT/US2017/050776

§ 371 Date: Mar. 7, 2019

Related U.S. Application Data
(60) Provisional application No. 62/385,200, filed on Sep. 8, 2016.

(51) Int. Cl. B60N 2/14; B60N 2/10

(52) U.S. Cl. CPC B60N 2/146; B60N 2/10

(57) ABSTRACT

A seating system for at least one occupant in a vehicle interior is disclosed. The seating system may provide a seat assembly comprising a base assembly configured to be mounted in the vehicle interior and a seat structure configured to be coupled to the base assembly and providing a seat configured for movement relative to the base assembly; movement of the seat relative to the base assembly may comprise at least two of (1) recline movement or (2) swivel movement or (3) tilt movement; recline movement may comprise generally translating movement of the seat structure; swivel movement may comprise rotational movement of the seat structure; tilt movement may comprise generally translating movement of the seat structure transverse to recline movement. The base assembly may comprise a mechanism configured to facilitate movement of the seat structure relative to the base assembly. The seat structure may comprise at least one of a shell; the seat may comprise a cushion, the seat structure may be removable from the base assembly.

### CROSS-REFERENCE TO RELATED APPLICATIONS

The present invention claims priority to and incorporates by reference in full the following U.S. patent application(s): U.S. Provisional Patent Application No. 62/385,200 titled “Seat Configuration for a Vehicle Such as an Autonomous Vehicle” filed on Sep. 8, 2016.

### FIELD

The present invention relates to a seat configuration for a vehicle. The present invention also relates to a seating system for a vehicle such as an autonomous vehicle. The present invention also further relates to a vehicle interior component such as a vehicle seat. The present invention further relates to a seat assembly comprising a base assembly and a seat structure.

### BACKGROUND

It is well known to provide a set of seats for occupants of a vehicle. It is also well known to provide a seat for a vehicle that comprises a seat base and a backrest. It is also known to provide a seat for a vehicle in which the seat base is installed to the vehicle interior on a set of floor tracks and at least partially adjustable in the set of floor tracks along a linear path. It is also known to provide a seat for a vehicle in which the seat base is at least partially adjustable along the set of floor tracks and the backrest is pivotally attached to the seat base and at least partially adjustable by pivotal movement relative to the seat base.

Such a conventional seat for a vehicle providing for sliding adjustment of the position of the seat base and for pivotal adjustment of the backrest relative to the seat base may be configured to provide for adjustments in a range generally to facilitate a range of size of vehicle occupants (such as a driver). In such a conventional seat for a vehicle, the adjustments are provided by separate mechanisms (e.g. a mechanism for sliding adjustment located under or at the seat base and a mechanism for pivotal adjustment of the backrest located at the back of the seat base and bottom of the backrest); in such a conventional seat arrangement the available adjustments are generally restricted to a linear direction for seat position adjustment (e.g. seat base movement constrained on the set of tracks) and pivotally for the backrest (e.g. constrained at the pivot point attaching the backrest to the seat base); in such a conventional seat arrangement the degree of comfort that may be provided to a vehicle occupant in the seat may be restricted by the constraints on available movement of the seat.

It would be advantageous to provide for a seat configuration for a vehicle interior providing for a plurality of available movements of the seat relative to the vehicle interior. It would also be advantageous to provide for a seat system that can be adjusted and configured for vehicle occupant use and comfort. It would further be advantageous to provide for a seat arrangement for a vehicle interior providing for a plurality of available movements including at least two movements such as recline movement and rotation/swivel movement and/or tilt/roll movement. It would further be advantageous to provide a seat assembly for a vehicle interior comprising an improved seat structure providing at least two movements for the seat to be mounted on an improved base arrangement providing a compact form. It would further be advantageous to provide a seat assembly for a vehicle interior comprising a seat movable in multiple directions relative to a base that is provided in a compact form. It would further be advantageous to provide a seat assembly that has a removable seat structure.

It would be advantageous to provide a seating system that provides at least one of the identified advantageous features or other features of potential benefit or use for a vehicle interior.

### SUMMARY

The present invention relates to a seating system for at least one occupant in a vehicle interior comprising a base assembly configured to be mounted in the vehicle interior and a seat structure configured to be coupled to the base assembly and providing a seat configured for movement relative to the base assembly; movement of the seat relative to the base assembly may comprise at least two of (1) recline movement or (2) swivel movement or (3) tilt movement; recline movement may comprise movement of the seat on a path; swivel movement may comprise rotational movement of the seat; tilt movement may comprise movement of the seat on a path. Movement of the seat may comprise each of (1) recline movement and (2) swivel movement and (3) tilt movement. Movement of the seat may comprise (1) recline movement in rotation about a first axis and (2) swivel movement in rotation about a second axis and (3) tilt movement in rotation about a third axis.

A seat assembly may be formed from installation of the seat structure on the base assembly at a pivot axis. The seat structure may be coupled to the base assembly at an interface. The interface may comprise at least one of (a) a pivot pin; (b) a post; (c) a fastener; (d) a threaded fastener; (e) a bolt with a cap; (f) a post with a cap; (g) a threaded shaft; (h) a bolt threaded into a mounting structure; (i) a post through at least one slot; (j) a post through at least two slots; (k) a fastener to secure the seat structure to the base assembly; (l) a component of a mechanism to facilitate movement of the seat structure relative to the base; (m) a component of a mechanism to retain the seat structure in a track; (n) a component to retain the seat structure by engagement with a latch mechanism; (o) a mounting point; (p) a pivot point; (q) an interface for a mechanism to facilitate movement of the seat relative to the base assembly; (r) a shaft; (s) a mechanism to facilitate movement of the seat. The base assembly may comprise a stand.

The base assembly may comprise a mechanism configured to facilitate movement of the seat relative to the base assembly. The mechanism may comprise at least one of (a) a pivot; (b) a post with a cap; (c) a clamp mechanism; (d) a clutch mechanism; (e) a set of plates to engage and disengage for movement of the seat; (f) a slot; (g) a set of slots; (h) a slot and keyway arrangement; (i) an actuator; (j) a motor; (k) a control system; (l) a central joint; (m) a brake; (n) a clamp; (o) a locking mechanism; (p) a manually operated mechanism; (q) a set of mechanisms; (r) a set of actuators; (s) a set of motors; (t) a generally central pivot point at the coupling of the seat structure to the base assembly; (u) a coupling of the seat structure to the base assembly; (v) a mechanism comprising a post; (w) an interface between the seat structure and the base assembly; (x) a mechanism interoperable with a latch mechanism for removal of the seat structure from the base assembly; (y) a mechanism located at the mounting point; (z) a mechanism to facilitate at least two of recline movement and tilt movement and swivel movement. The set of plates to engage and disengage may comprise at least one plate from the base assembly and a plate from the seat structure. The set of plates operate as a clamp when engaged and release to seat for movement with reduced friction when disengaged. The mechanism may provide (1) a disengaged mode wherein seat structure may be freely movable relative to the base assembly; and (2) a partially engaged mode wherein seat structure may be retained in position but movable relative to the base assembly by application of enhanced force; (3) an engaged mode wherein seat structure may be clamped in position relative to the base assembly.

The seat structure may comprise at least one of (a) a shell; (b) an exterior shell; (c) a one-piece molded shell; (d) a carrier; (e) a carrier cup; (f) a carrier for the seat; (g) a generally spherical-shaped shell; (h) a plastic molded shell. The seat may comprise at least one of (a) a cushion; (b) a pad, (c) a foam cushion; (d) a liner; (e) a cover (f) a foam material; (g) an adaptive foam material; (h) a visco-elastic material; (i) an inflatable segment; (j) a fillable segment; (k) a shape-memory material; (c) a one-piece exterior shell.

The seat structure may be removable from the base assembly. The seat structure may be removable by disengagement of a latch mechanism. The latch mechanism may comprise a button and a latch; the mechanism to facilitate movement of the seat relative to the base may comprise a post with a cap; the latch may be configured to engage the cap of the post to retain the seat structure and to disengage the cap of the post to release the seat structure for removal from the base assembly. The latch mechanism provides a stop for recline movement. The seat structure may be removable by operation of a mechanism to facilitate movement of the seat relative to the base assembly and by disengagement of the latch mechanism retaining the seat structure on the base assembly.

Movement of the seat relative the base assembly may be at least one of (a) actuated by an actuator of (b) assisted by an actuator; (c) manually operated by an occupant; (d) by body displacement of an occupant; (e) by body position shift of an occupant; (f) autonomous in operation of the vehicle; (g) configured to return the seat to a default position relative to the base assembly when the seat may be empty. Recline movement may comprise generally translating movement of the seat. Tilt movement may comprise generally translating movement of the seat. The path of tilt movement may be generally transverse to the path of recline movement. Recline movement may be at least one of (a) guided within a slot; (b) in a forward and rearward direction relative to the seat; (c) curved movement; (d) lifting movement; (e) guided within a longitudinal slot; (f) guided by a post in the slot; (g) along a curved track; (h) in a range of movement asymmetrical relative to the seat. The path of recline movement may be at least one of (a) curved; (b) at least partially curved; (c) about an axis; (d) configured to recline the seat; (e) used to remove the seat structure from the base assembly; (f) constrained by a mechanism; (g) defined by a slot; (h) defined by a track; (i) terminated at a stop; (j) generally transverse to the path of tilt movement. Tilt movement may be at least one of (a) guided within a slot; (b) in a lateral direction relative to the seat; (c) curved movement; (d) lifting movement; (e) transverse to recline movement; (f) guided by a post in a slot; (g) along a curved track; (h) in a range of movement symmetrical relative to the seat. Swivel movement may be at least one of (a) may be about the pivot; (b) about a central joint; (c) about an axis aligned with the base assembly; (d) about a fixed post; (e) in a range of movement symmetrical to the seat. Movement may comprise independent movement so that recline movement may occur without at least one of swivel movement and tilt movement. Movement may comprise combined movement so that recline movement may occur simultaneous with at least one of swivel movement and tilt movement. Movement may comprise independent movement so that (a) tilt movement may occur without at least one of swivel movement and recline movement; (b) swivel movement may occur without at least one of recline movement and tilt movement; (c) recline movement may occur without at least one of swivel movement and tilt movement. Movement of the seat relative to the base assembly may be actuated by body displacement from the occupant in the seat.

The seating system may comprise a first seat assembly and a second seat assembly; a seat structure of the first seat assembly may be configured to be removed from the base assembly of the first seat assembly and stacked on a seat structure of the second seat assembly. The seat structure of first seat assembly may be configured to be nested on the seat structure of the second seat assembly. The seat system may comprise at least two seat assemblies.

The seat structure may be coupled to the base assembly at a single mechanism and/or single mounting point. The base assembly may comprise a structure that can be physically and visually integrated with other features and forms of the vehicle interior; other features and forms of the vehicle interior comprise at least one of (a) door panel; (b) instrument panel; (c) vehicle interior components.

The present invention relates to a seat assembly for a vehicle interior comprising a base configured to be mounted in the vehicle interior and a seat structure configured to be coupled to the base and providing a seat configured for movement relative to the base assembly; and a mechanism to couple the seat structure to the base; movement of the seat relative to the base may comprise at least recline movement; recline movement may comprise movement of the seat on a path defined by the mechanism. The mechanism may comprise at least one of (a) a mechanism to facilitate movement of the seat relative to the base; (b) a slot providing the path; (c) a clamp mechanism; (d) a clutch-plate mechanism; (e) a set of plates configured to be engaged and disengaged. Movement of the seat relative to the base assembly may comprise tilt movement and swivel movement. The seat assembly may comprise a latch mechanism to facilitate removal of the seat structure from the base.

The present invention relates to a seat assembly for at least one occupant in a vehicle interior comprising a base configured to be mounted in the vehicle interior and a seat configured to be coupled to the base and configured for movement relative to the base with a mechanism providing an interface to couple the seat to the base and a mechanism to facilitate removal of the seat from the base; movement of the seat relative to the base may comprise at least two of (1) recline movement or (2) swivel movement or (3) tilt movement; recline movement may comprise movement of the seat on a path; swivel movement may comprise rotational movement of the seat; tilt movement may comprise movement of the seat on a path. The interface may comprise a shaft. The seat may comprise a shell structure.

The present invention relates to a seat assembly for a vehicle interior comprising a base configured to be mounted in the vehicle interior and a seat structure configured to be coupled to the base and providing a seat configured for movement relative to the base assembly and a mechanism configured to couple the seat structure to the base; the mechanism is configured to define a path of movement of the seat relative to the base. The mechanism comprises at least one of (a) a mechanism to facilitate movement of the seat relative to the base; (b) a slot providing the path; (c) a clamp mechanism; (d) a clutch-plate mechanism; (e) a set of plates configured to be engaged to retain the seat in position with the base and disengaged for movement of the seat relative to the base; (f) at least one actuator; (g) a pivot shaft with a cap; (h) a pivot post. Movement of the seat relative to the base comprises at least one of (1) recline movement and (2) swivel movement and (3) tilt movement.

The present invention relates to a seat assembly for a vehicle interior comprising a base configured to be mounted in the vehicle interior and a seat structure configured to be coupled to the base and providing a seat configured for movement relative to the base assembly and a mechanism configured to couple the seat structure to the base; the mechanism is configured to provide a path of movement of the seat relative to the base; movement of the seat relative to the base comprises at least one of (1) recline movement and (2) swivel movement and (3) tilt movement. The mechanism comprises at least one of (a) a mechanism to facilitate movement of the seat relative to the base; (b) a slot providing the path; (c) a clamp mechanism; (d) a clutch-plate mechanism; (e) a set of plates configured to be engaged to retain the seat in position with the base and disengaged for movement of the seat relative to the base; (f) at least one actuator; (g) a post for swivel movement; (h) a slot for recline movement and a slot for tilt movement generally transverse to the slot for recline movement.

The present invention relates to a seating system for at least one occupant in a vehicle interior comprising a base assembly configured to be mounted in the vehicle interior and a seat structure configured to be coupled to the base assembly and providing a seat configured for movement relative to the base assembly; movement of the seat relative to the base assembly may comprise at least two of (1) recline movement or (2) swivel movement or (3) tilt movement; recline movement may comprise generally translating movement of the seat structure; swivel movement may comprise rotational movement of the seat structure; tilt movement may comprise generally translating movement of the seat structure transverse to recline movement. Movement of the seat structure may comprise each of (1) recline movement and (2) swivel movement and (3) tilt movement. Movement of the seat structure may comprise (1) recline movement in rotation about a first axis and (2) swivel movement in rotation about a second axis and (3) tilt movement in rotation about a third axis.

The seat assembly may be formed from installation of the seat structure on the base assembly at the pivot point. The pivot point may comprise at least one of (a) a pivot pin; (b) a post; (c) a fastener; (d) a threaded fastener; (e) a bolt with a cap; (f) a post with a cap; (g) a threaded shaft; (h) a bolt threaded into a mounting structure; (i) a post through at least one slot; (j) a post through at least two slots; (k) a fastener to secure the seat structure to the base assembly; (l) a component of a mechanism to facilitate movement of the seat structure relative to the base; (m) a component of a mechanism to retain the seat structure in a track; (n) a component to retain the seat structure by engagement with a latch mechanism. The base assembly may comprise a stand. The base assembly may comprise a mechanism configured to facilitate movement of the seat structure relative to the base assembly. The mechanism may comprise at least one of (a) a pivot; (b) a post/shaft with a cap; (c) a clamp mechanism; (d) a clutch mechanism; (e) a set of plates to engage and disengage; (f) a slot; (g) a set of slots; (h) a slot and keyway arrangement; (i) an actuator; (j) a motor; (k) a control system; (l) a central joint; (m) a brake; (n) a clamp; (o) a locking mechanism; (p) a manually operated mechanism; (q) a set of mechanisms; (r) a set of actuators; (s) a set of motors; (t) a central pivot point/axis. The set of plates may comprise a plate from the base assembly and a plate from the seat structure. The mechanism may provide (1) a disengaged mode wherein the seat structure may be freely movable relative to the base assembly; and (2) a partially engaged mode wherein the seat structure may be retained in position but movable relative to the base assembly by application of enhanced force; (3) an engaged mode wherein the seat structure may be clamped in position relative to the base assembly.

The seat structure may be coupled to the base assembly at a single mechanism and/or single interface. The base assembly may comprise a structure that can be physically and visually integrated with other features and forms of the vehicle interior.

### FIGURES

FIG. 1A is a schematic perspective view of a vehicle according to an exemplary embodiment.

FIG. 1B is a schematic perspective cut-away view of a vehicle showing a vehicle interior with a seating system providing seat assemblies according to an exemplary embodiment.

FIG. 1C is a schematic perspective view of a vehicle interior with a seating system providing seat assemblies according to an exemplary embodiment.

FIGS. 1D and 1E are schematic elevation views of a seat assembly according to an exemplary embodiment.

FIGS. 2A-2L are schematic partial perspective views of a seat assembly according to an exemplary embodiment.

FIG. 3A is a schematic exploded perspective view of a seat structure of a seat assembly according to an exemplary embodiment.

FIG. 3B is a schematic exploded perspective view of a base assembly for a seat assembly according to an exemplary embodiment.

FIG. 3C is a schematic partial exploded perspective view of a seat assembly according to an exemplary embodiment.

FIG. 3D is a schematic partial perspective view of a seat assembly according to an exemplary embodiment.

FIGS. 4A-4L are schematic partial perspective views of a seat assembly according to an exemplary embodiment.

FIGS. 5A-5L are schematic partial elevation views of a seat assembly according to an exemplary embodiment.

FIGS. 6A-6F are schematic partial plan views of a seat assembly according to an exemplary embodiment.

FIG. 7A is a schematic partial perspective views of a seat assembly according to an exemplary embodiment.

FIGS. 7B-7C are schematic partial elevation views of a seat assembly according to an exemplary embodiment.

FIGS. 8A-8D are schematic partial plan views of a seat assembly according to an exemplary embodiment.

FIG. 9A is a schematic exploded perspective view of a seat structure of a seat assembly according to an exemplary embodiment.

FIG. 9B is a schematic exploded perspective view of a base assembly for a seat assembly according to an exemplary embodiment.

FIG. 9C is a schematic partial exploded perspective view of a seat assembly according to an exemplary embodiment.

FIG. 9D is a schematic partial perspective view of a seat assembly according to an exemplary embodiment.

FIG. 9E is a schematic exploded perspective view of a base assembly for a seat assembly according to an exemplary embodiment.

FIGS. 10A-10B are schematic partial elevation views of a seat assembly with occupant according to an exemplary embodiment.

FIGS. 10C-10D are schematic partial elevation views of a seat assembly with mechanism according to an exemplary embodiment.

FIGS. 10E-10F are schematic partial plan views of a mechanism for a seat assembly according to an exemplary embodiment.

FIGS. 11A-11B are schematic partial elevation views of a seat assembly with occupant according to an exemplary embodiment.

FIGS. 11C-11D are schematic partial elevation views of a seat assembly with mechanism according to an exemplary embodiment.

FIGS. 11E-11F are schematic partial plan views of a mechanism for a seat assembly according to an exemplary embodiment.

FIGS. 12A-12B are schematic partial elevation views of a seat assembly with occupant according to an exemplary embodiment.

FIGS. 12C-12D are schematic partial elevation views of a seat assembly with a mechanism according to an exemplary embodiment.

FIGS. 12E-12F are schematic partial plan views of a mechanism for a seat assembly according to an exemplary embodiment.

FIG. 13A is a schematic elevation cross-section view of a seat assembly according to an exemplary embodiment.

FIG. 13B is a schematic partial elevation cross-section view of a seat assembly according to an exemplary embodiment.

FIGS. 13C and 13D are schematic partial perspective views of a seat assembly according to an exemplary embodiment.

FIGS. 14A-14F are schematic partial elevation cross-section views of a seat assembly according to an exemplary embodiment.

FIGS. 15A-15D are schematic partial elevation cross-section views of mechanism for a seat assembly according to an exemplary embodiment.

FIGS. 16A-16F are schematic partial elevation cross-section views of a seat assembly according to an exemplary embodiment.

FIGS. 17A-17D are schematic partial elevation cross-section views of mechanism for a seat assembly according to an exemplary embodiment.

FIG. 18 is a schematic partial perspective view of a mechanism for a seat assembly according to an exemplary embodiment.

FIG. 19A is a schematic perspective view of a seat assembly according to an exemplary embodiment.

FIG. 19B is a schematic elevation cross-section view of a seat structure of a seat assembly according to an exemplary embodiment.

FIG. 19C is a schematic perspective view of a seat assembly according to an exemplary embodiment.

FIG. 19D is a schematic partial exploded perspective view of a seat structure of seat assembly according to an exemplary embodiment.

FIGS. 19E-19F are schematic partial elevation views of a seat structure of a seat assembly according to an exemplary embodiment.

FIGS. 20A-20C are a schematic perspective views of a vehicle interior with a seating system providing seat assemblies according to an exemplary embodiment.

FIGS. 21A-21D are a schematic perspective views of a vehicle interior with a seating system providing seat assemblies according to an exemplary embodiment.

FIGS. 22A-22C are a schematic perspective views of a vehicle interior with a seating system providing seat assemblies according to an exemplary embodiment.

### DESCRIPTION

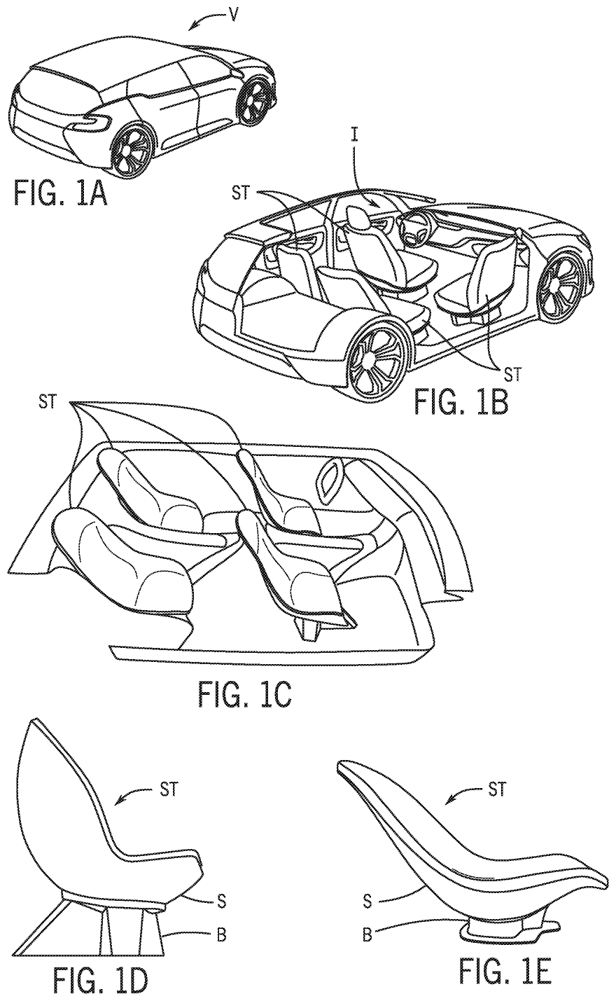

Referring to FIGS. 1A through 1C, a vehicle V is shown schematically with a seat assembly ST as part of a seating system according to an exemplary embodiment; as shown schematically in FIGS. 1D and 1E, the seat assembly ST may comprise a base assembly B and a seat structure S (shown as comprising a shell); as indicated schematically the base assembly is provided in a generally compact arrangement configured to be mounted in the vehicle interior (e.g. at the floor). As indicated schematically according to an exemplary embodiment in FIGS. 1A-1C and FIGS. 20A-20C, 21A-21C and 22A-22D, the seating system may be provided for any of a wide variety of vehicles including but not limited to conventional automotive vehicles, hybrid-electric vehicles, electric vehicles, alternative fuel/energy vehicles, work vehicles, passenger vehicles, autonomous vehicles, etc. having any of a wide variety of interior configurations.

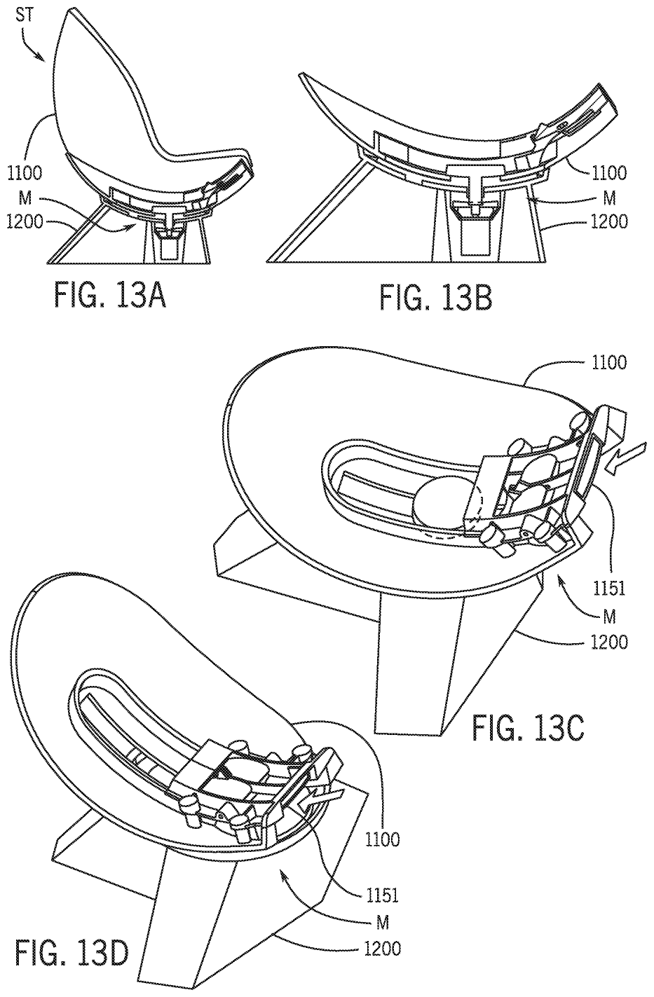

As indicated schematically according to an exemplary embodiment, a set of seat assemblies ST may be provided in the vehicle interior I (e.g. for a vehicle operator/driver and vehicle occupants in a conventional “front” and rear” arrangement); each seat assembly ST may provide a seat/seat arrangement configured for use and/or adjustment by a vehicle occupant. See FIGS. 1B-1C and 1D-1E. See also FIGS. 13A, 19A-19D, 20A-20C, 21A-21C and 22A-22D. As indicated schematically according to an exemplary embodiment, the seating system may comprise one seat assembly or multiple seat assemblies that may be configured and arranged as suitable for particular vehicle interior and/or as suitable in operation of the vehicle. See FIGS. 1B-1E, 19A-19D, 20A-20C, 21A-21C and 22A-22D.

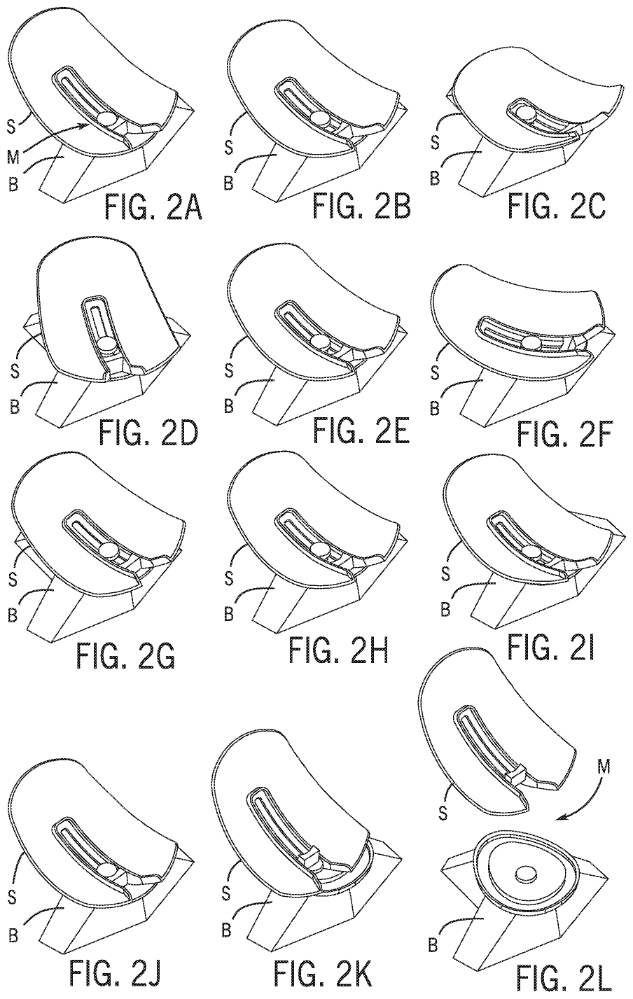

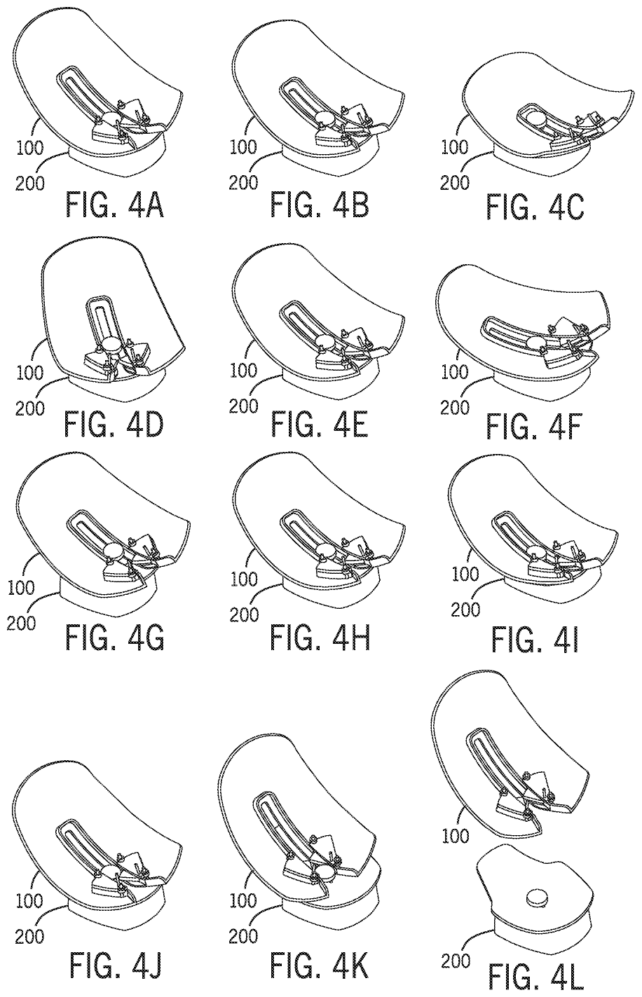

Referring to FIGS. 2A-2L, as shown schematically according to an exemplary embodiment, the seat assembly ST may provide a mechanism M configured to provide for a set of multiple available movements for the seat structure S (shown partially) relative to the base assembly B including a recline movement (with the seat moved to the front/downward and back/upright) (see FIGS. 2A-2C) and/or a rotation movement (to pivot/swivel the seat in position) (see FIGS. 2D-2F) and/or a roll/tilt movement (with the seat moved to the side/laterally and upward/downward) (see FIGS. 2G-2I). As indicated, the mechanism M may be configured to facilitate a composite movement of the seat (e.g. recline movement and roll/tilt movement, recline movement and rotation movement, etc.). As shown schematically in FIGS. 2J-2L, the seat structure S (shown partially) may also be disengaged/detached and removed/separated from the base assembly B. See also FIGS. 4A-4L.

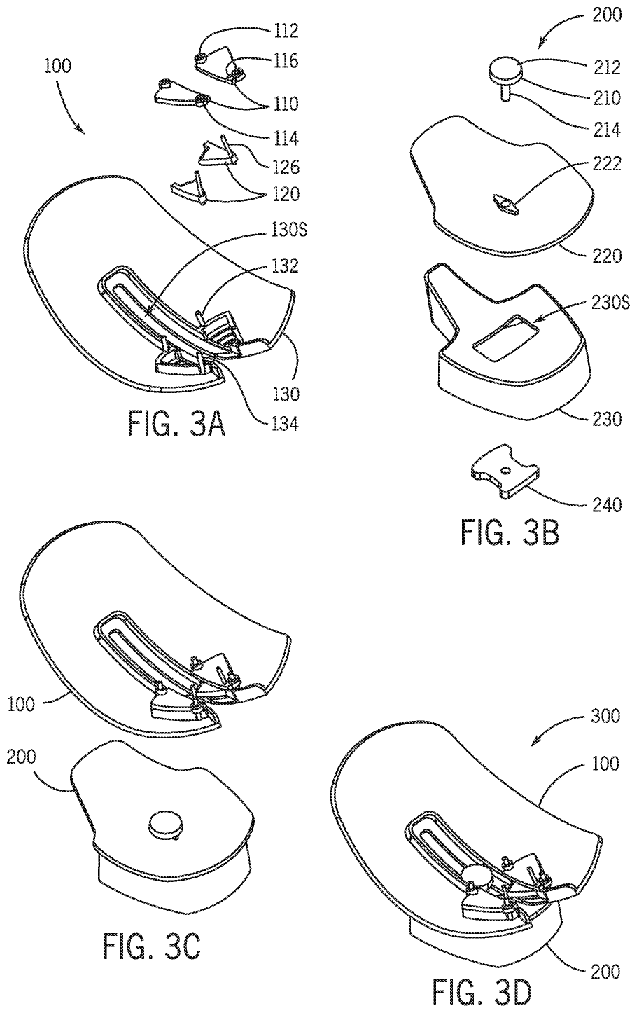

As shown schematically in FIGS. 3A-3D according to an exemplary embodiment, a seat configuration/assembly 300 may comprise a seat structure/assembly 100 coupled to a base assembly 200. According to an exemplary embodiment shown schematically in FIGS. 3A and 3C, the seat structure/assembly 100 (shown partially) may comprise a substrate shown as a shell structure 130 (with pins 132 and 134) providing a slot 130s and a retainer assembly shown as comprising a set of retainer flanges 110 and a set of tabs of stops 120. As shown schematically, retainer flanges 110 provide mounting holes 112/114 to engage pins 132/134 of the shell structure 130 (e.g. for assembly) and provide mounting holes 116 to engage pins 126 of the set of tabs or stops 120; tabs/stops 120 are pivotally attached to the shell structure 130 and movable/biased into position (e.g. by a spring force) at the opening of the slot 130s of the shell structure 130. According to an exemplary embodiment shown schematically in FIGS. 3B and 3C, the base assembly 200 may comprise a base structure or stand 230 with a slot 230s and a cover plate 220 attached by pivot pin or post 210 (shown as a threaded fastener with a cap 212 and bolt section 214) that engages a mounting structure shown as a mounting plate 240 (with threaded hole to engage the bolt section of the fastener). As shown schematically according to an exemplary embodiment in FIG. 3D, the seat assembly 300 (shown partially) may comprise the seat structure/assembly 100 installed onto the base assembly 200 at an interface providing a mechanism for movement of the seat relative to the base/stand (e.g. with the shell engaged on the pin or post and retained by the set of tabs/stops).

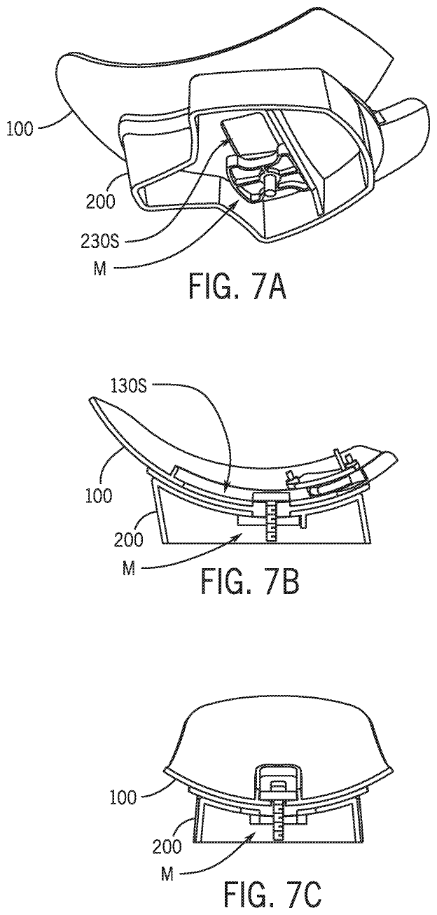

As shown schematically according to an exemplary embodiment in FIGS. 4A-4L, the seat arrangement with interface/mechanism may provide for a set of multiple available adjustments/movements for the seat structure S/100 (shown partially) relative to the base assembly B/200 including a recline movement engaging the pivot post/pin within the slot (see FIGS. 4A-4C, 5A-5C, 7B-7C and 8D) and/or a rotation movement at the pivot post/pin (see FIGS. 4D-4F, 5D-5F, 6B, 6D, 6F and 7A-7C) and/or a roll/tilt movement engaging the pivot pin/post within a transverse slot or track with keyway (see FIGS. 4G-4I, 5G-5I, 6A, 6C, 6E and 7A-7C); the seat structure 100 (shown partially) may also be separated/removed from the base assembly 200 (e.g. by disengagement of the pivot pin/post from the slot by release at the set of tabs/stops which retract into a set of recesses in the shell structure) (see FIGS. 4J-4L, 5J-5L and 8A-8D). See also FIGS. 2A-2L.

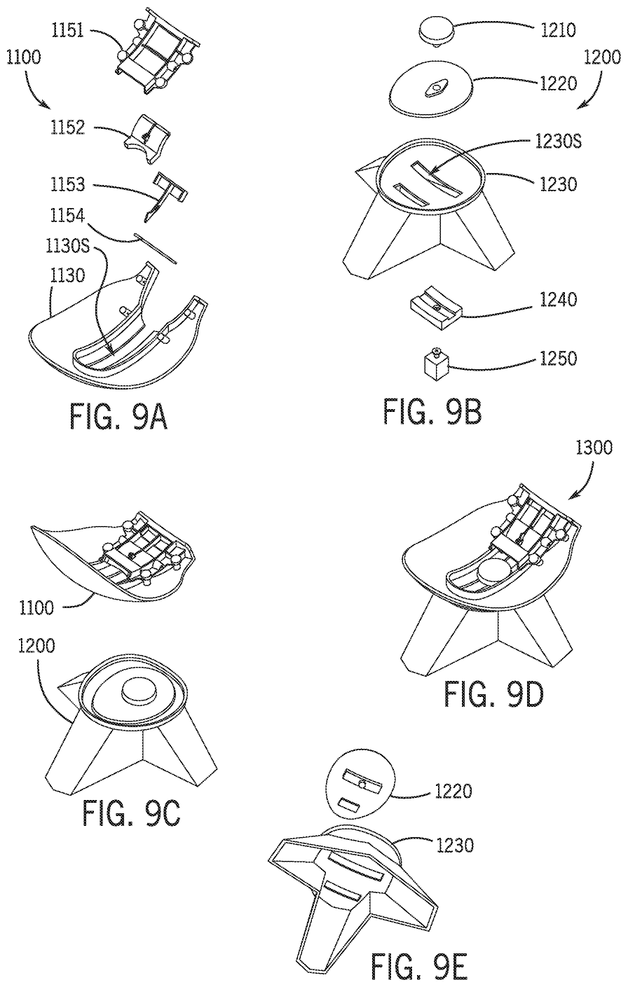

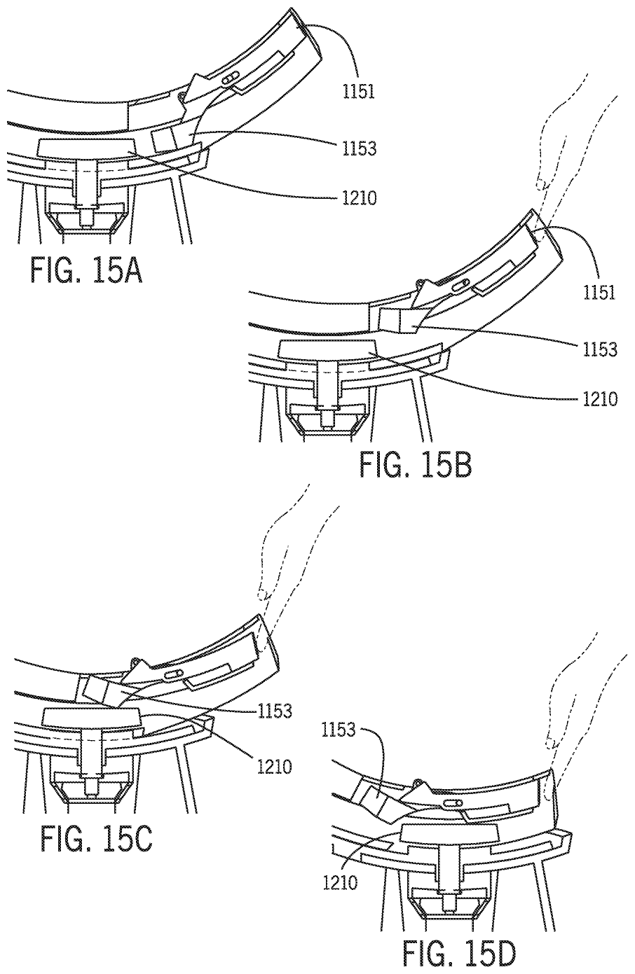

As shown schematically in FIGS. 9A-9E according to an exemplary embodiment, a seat configuration/assembly 1300 may comprise a seat structure/assembly 1100 coupled to a base assembly 1200. According to an exemplary embodiment shown schematically in FIGS. 9A and 9C-9D, the seat structure/assembly 1100 (shown partially) may comprise a substrate shown as a shell structure 1130 providing a slot 1130s and a retainer/stop assembly shown as comprising a bracket or housing 1151 providing a button/surface and frame section 1152 to engage a guide/lever flange 1153 with an axle 1154 (e.g. in an arrangement pivotally movable and biased into position by a spring force) configured to function as a stop/latch at the opening of the slot 1130s of the shell structure 1130. According to an exemplary embodiment shown schematically in FIGS. 9B and 9C-9D, the base assembly 1200 may comprise a base structure or stand 1230 with a slot 1230s and a cover plate 1220 attached by pivot pin or post 1210 (shown as a threaded fastener with a head/cap and bolt section) that engages a mounting structure shown as a mounting plate 1240 with retainer 1250 (with threaded mount/hole to engage the bolt section of the fastener). As indicated schematically according to an exemplary embodiment in FIGS. 9C-9D, the retainer/stop assembly with guide/lever flange 1153 operates as a latch/retainer for the pivot pin/post 1210. See also FIGS. 13A-13D and 15A-15D. As shown schematically according to an exemplary embodiment in FIG. 9D, the seat assembly 1300 (shown partially) may comprise the seat structure/assembly 1100 installed onto the base assembly 1200 at an interface providing a mechanism for movement of the seat relative to the base/stand (e.g. with the shell engaged on the pin or post and retained by guide/lever and bracket arrangement of the retainer/stop assembly). See also FIGS. 1D-1E, 13A and 19A-19D.

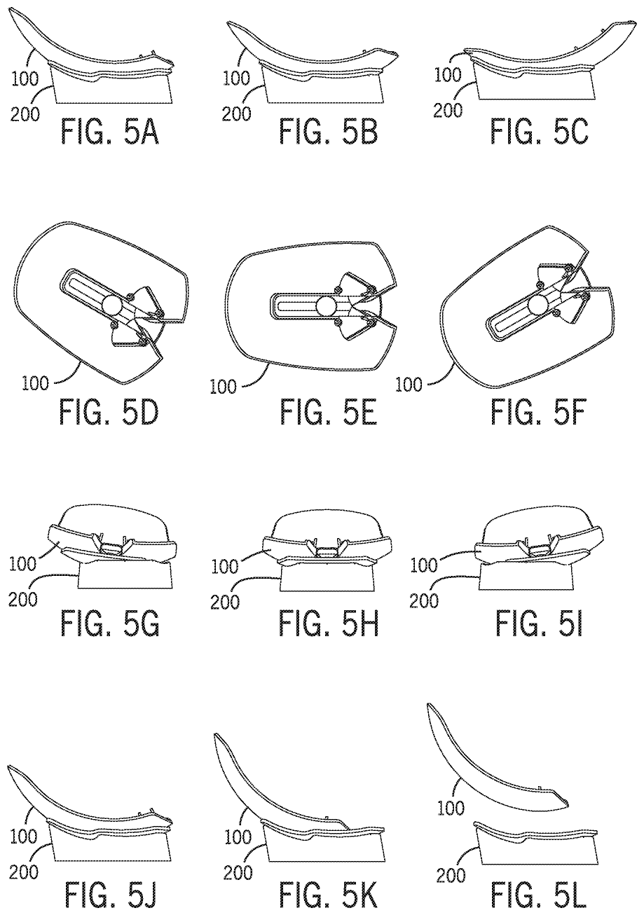

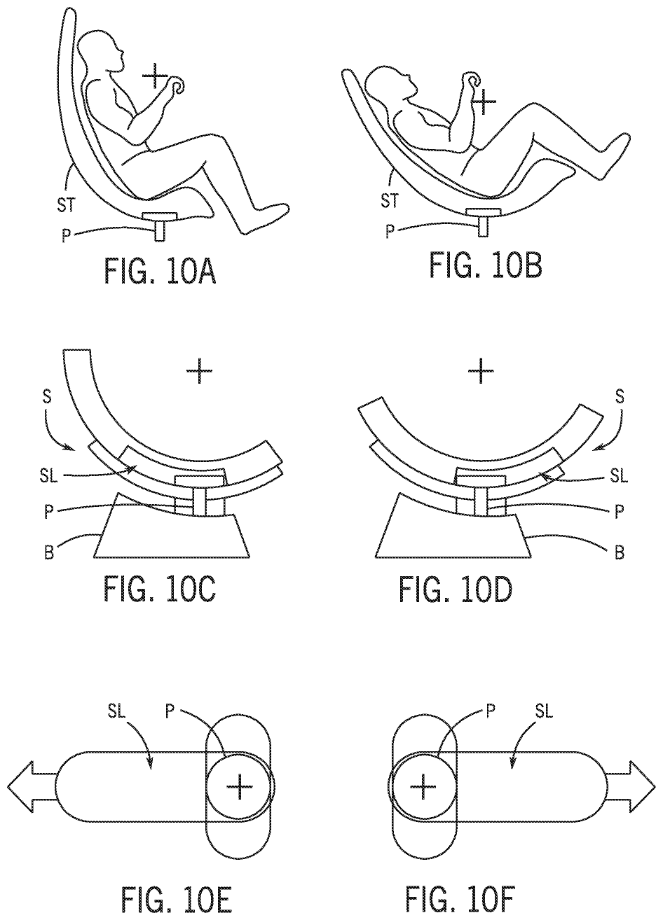

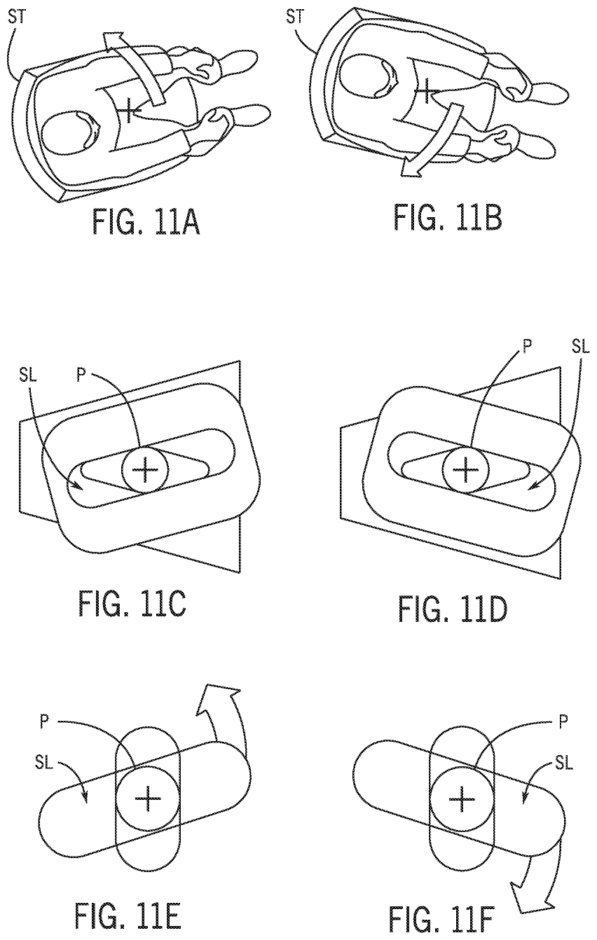

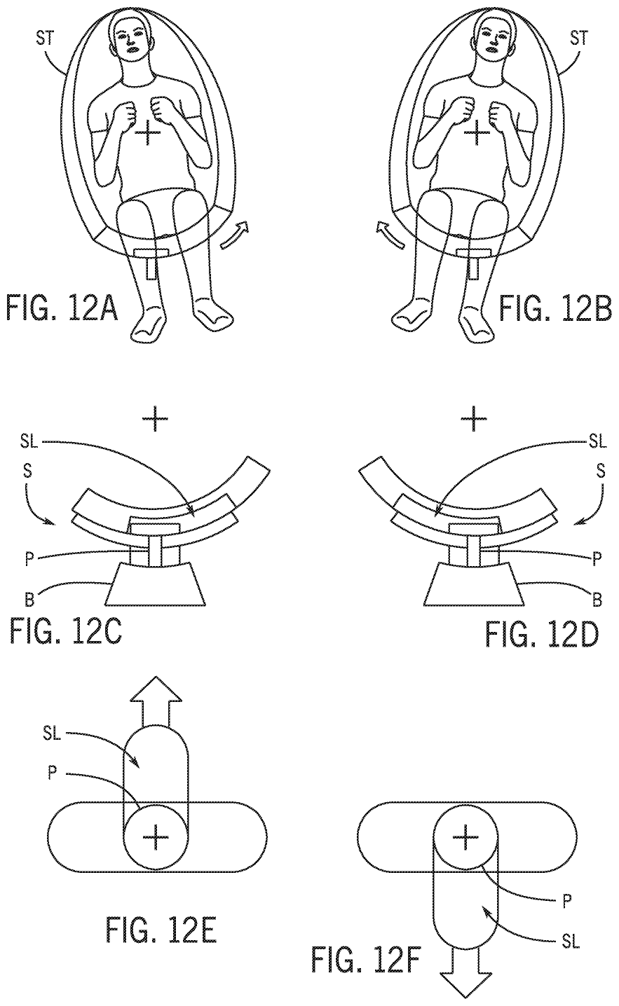

As shown schematically according to an exemplary embodiment in FIGS. 10A-10F, 11A-11F and 12A-12F, the seat arrangement with interface/mechanism may provide for a set of multiple available adjustments/movements for the seat structure S/1100 (shown partially) relative to the base assembly B/1200 including a recline movement engaging the pivot post/pin within the slot (see FIGS. 10A-10F and 13A-13D) and/or a rotation/swivel movement at the pivot post/pin (see FIGS. 11A-11F) and/or a roll/tilt movement engaging the pivot pin/post within a transverse slot or track with keyway (see FIGS. 12A-12F). See also FIGS. 2A-2I and 5A-5I.

As shown schematically according to an exemplary embodiment in FIGS. 10A-10F, the recline movement of the seat is provided at a mechanism M by translating/sliding movement of the seat S relative to the base B; the translating/sliding movement of the seat is provided as the slot SL of the shell structure is engaged by pivot pin/post P; as shown schematically, the extent of the recline movement is determined by the length of the slot between the terminus of the slot in the shell structure and a stop/retainer provided by the mechanism. See FIGS. 10C-10D and 10E-10F. See also FIGS. 5A-5C.

As shown schematically according to an exemplary embodiment in FIGS. 11A-11F, the rotation/swivel movement of the seat is provided at a mechanism M by rotation of the seat S relative to the base B; the rotation of the seat is provided by the pivot pin/post; as shown schematically, the extent of the recline movement can be determined configuration of the mechanism (e.g. installation of stops). See FIGS. 11C-11D and 11E-11F. See also FIGS. 5D-5F.

As shown schematically according to an exemplary embodiment in FIGS. 12A-12F, the roll/tilt movement of the seat (e.g. tilt) is provided at a mechanism M by translating/sliding movement of the seat S relative to the base B; the translating/sliding movement of the seat is provided as slot SL of the shell structure is engaged by pivot pin/post P (guided by a key/keyway arrangement); as shown schematically, the extent of the recline movement is determined by the length of the slot as provided by the mechanism configuration. See FIGS. 12C-12D and 12E-12F. See also FIGS. 5G-5I.

As indicated schematically, according to an exemplary embodiment the seat may be configured to implement one or more of the movements (e.g. recline movement, rotation movement, roll movement); implementation in the seat assembly of each of the movements as shown schematically for the seat (e.g. with the mechanism arrangement as indicated) provides an expansive range of movement for the seat in multiple directions and orientations to facilitate occupant comfort and functionality (including occupant interaction, etc.) within the vehicle; removal/nesting of seats not in use provides a range of vehicle interior modifications to facilitate occupant comfort and functionality. See e.g. FIGS. 10A-10B, 11A-11B, 12A-12B, 20A-20C, 21A-21C and 22A-22D. As indicated schematically according to an exemplary embodiment, the occupant when seated in the seat may be provided with an opportunity to adjust the seat for any of a wide variety of purposes including optimized driver positioning, passenger rest/relaxation, ergonomic tuning/enhancement, adjustment to fit occupant size and for comfort/preferences, communications/interaction with occupants in multiple sections of the interior, privacy/screening, etc. as well as generally to provide a sensation of flexibility (e.g. ability to adjust to body displacement/anatomical positioning, “floating seat” sensation, etc.) from the wide range of adjustability/repositioning. As indicated schematically according to an exemplary embodiment, the seating system provides a compact base structure that can be physically and visually integrated with other features and forms of the vehicle interior.

As indicated schematically according to an exemplary embodiment, a seat assembly may be configured to provide for movement of a variety of types and degrees/distance (extent/range); for example, according to an exemplary embodiment, in implementation of the seat/mechanism of the recline movement may be configured from a range of about +7.5 degrees to −20 degrees (maximum recline) (see e.g. FIGS. 10A-10F with post P engaged in slot SL); the rotate/swivel movement may be configured in a range of +/−18 degrees (rotation from center) (see FIGS. 11A-11F with post A engaged with slot SL); the tilt/roll movement may be configured in a range of about +/−5 degrees (see FIGS. 12A-12F with post P engaged with slot SL). According to an exemplary embodiment, the range of movement for each movement may be varied or adjusted (e.g. increased, decreased, etc.) as suitable or intended (e.g. by design), for example, range of recline movement may be reduced or extended to fit a purpose/space or vehicle; range of rotation movement and/or tilt/roll movement may be provided in an asymmetrical configuration, etc.; range of movement may vary from seat to seat within a vehicle.

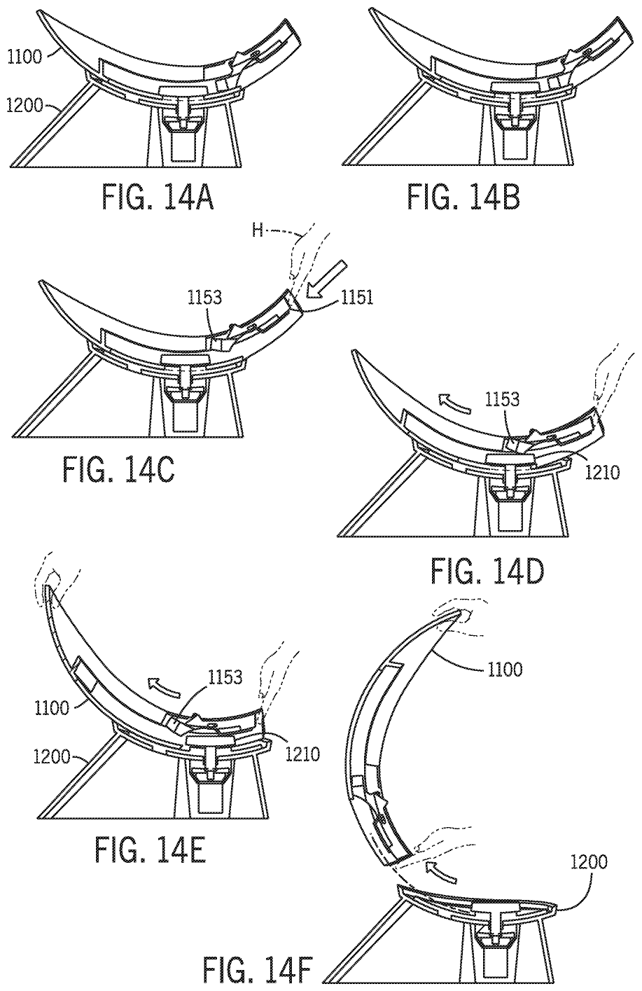

As shown schematically in FIGS. 13A-13D, 14A-14F and 15A-15D, according to an exemplary embodiment, the seat structure S/1100 (shown partially) may be separated/removed from the base assembly B/1200 by disengagement of the head/cap of pivot pin/post 1210 from the slot and release at the retainer/stop assembly with actuation at the button on member 1151 (e.g. to overcome the spring force) and lifting of the guide/lever flange 1153 (e.g. over the head/cap of the pivot pin/post 1210) as the seat structure is guided (see FIGS. 14C-14E and 15B-15D) and then lifted from disengagement with the base/stand (see FIG. 14F). See FIGS. 13C-13D (showing full seat structure). See also FIGS. 2J-2L and 5J-5L.

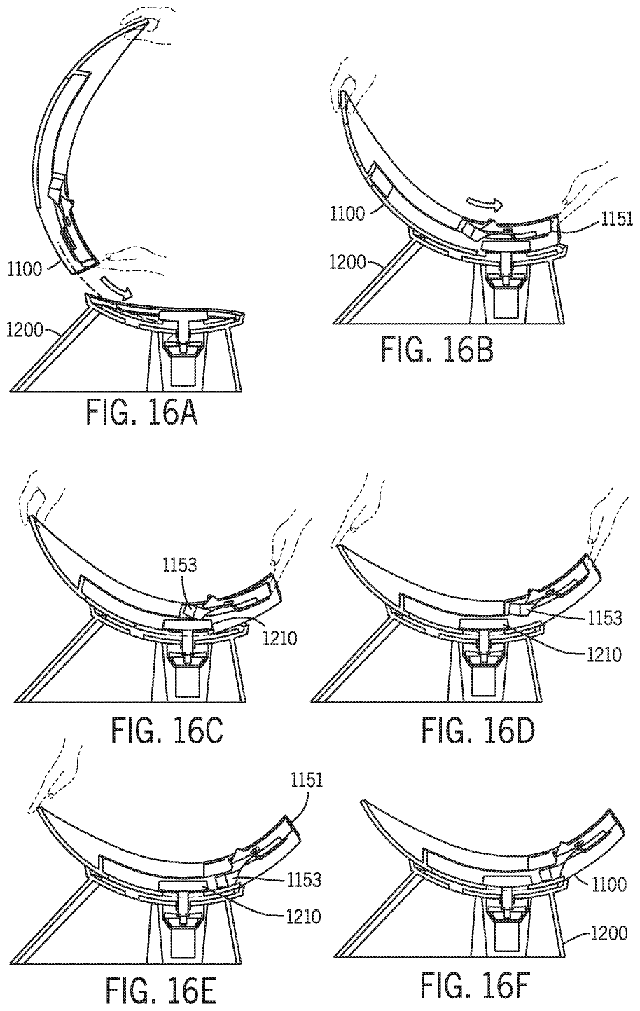

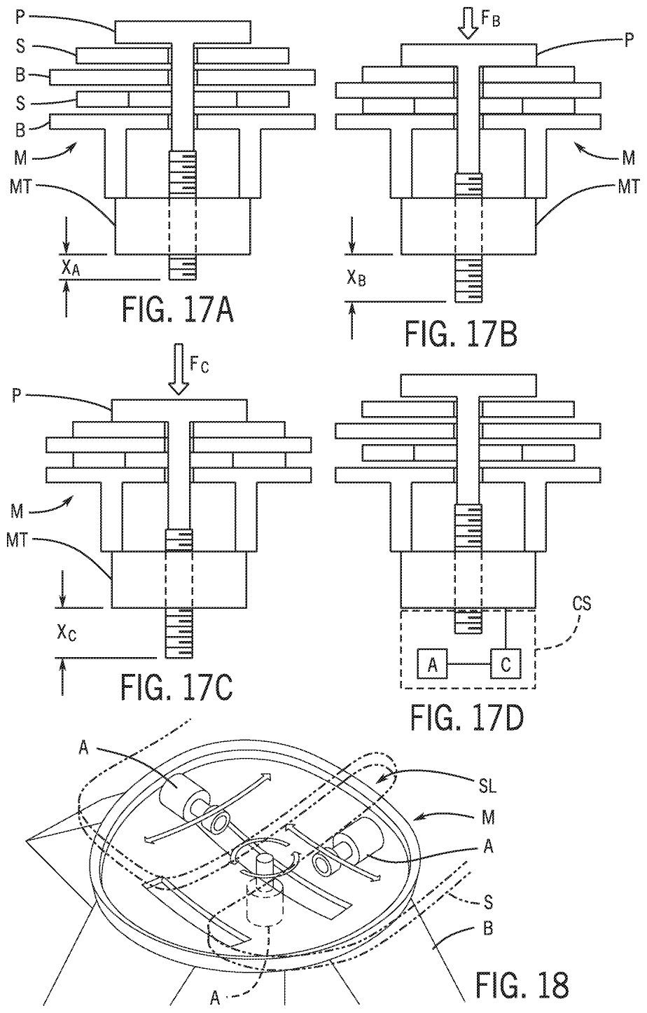

As shown schematically in FIGS. 16A-16F according to an exemplary embodiment, the seat structure S/1100 (shown partially) may be installed (or reinstalled) on the base assembly B/1200 by engagement of the head/cap of pivot pin/post 1210 into the slot at the retainer/stop assembly with actuation at the button surface on bracket 1151 (e.g. to overcome a spring force) and lifting of the guide/lever flange 1153 (e.g. over the head/cap of the pivot pin/post 1210) as the seat structure is guided (see FIGS. 16B-16D) and then seated into the base/stand as the pivot/pin 1210 is drawn into the mounting structure (see FIGS. 16E-16F and 17A-17C). See also FIGS. 13C-13D (showing full seat structure). As indicated schematically in FIGS. 14A, 16A-16F and 17A-17C, the seat structure assembly may be released for disengagement/separation and/or for adjustment and/or retained at the pivot pin/post P/1210 and mounting structure shown as mounting unit MT/1240/1250 by release and application of force (e.g. provided by an actuator/control system with spindle) operating as a clamp/clutch mechanism to retain and release plates/surfaces of the base assembly B and seat structure S. As indicated schematically in FIG. 17A, with no applied force the seat structure S is free to move relative to the base assembly B (e.g. base/stand and pin/post P and mounting structure MT extend distance XA); as indicated schematically in FIG. 17B, with application of force FB the seat structure is movable (e.g. against resistance) relative to the base assembly B (e.g. base/stand and pin/post P with mounting structure MT extend distance XB). See also FIGS. 14B-14F and 16B-16D. As indicated schematically in FIG. 17C, with application of force FC the seat structure S is retained in the base assembly B (e.g. retained in base/stand by pin/post P and mounting structure MT extending at distance XC). See also FIGS. 16E-16F.

As indicated schematically according to an exemplary embodiment in FIGS. 17D and 18, the mounting structure and any adjustment mechanism for the seat assembly may be operated by manual controls and/or actuators such as motor systems (e.g. electric motor), etc.; as shown schematically in FIG. 17D, the mechanism M may comprise a control system CS with an actuator and control element (e.g. a motor such as an electric motor configured to engage the mounting structure MT and pin/post P, operating as a clamp and/or clutch mechanism). See FIGS. 13A-13B (showing actuator for clamp/clutch mechanism for pin/post P). See also FIGS. 14A-14F and 16A-16F. As shown schematically in FIG. 18, the mechanism M for adjustment/movement for the seat assembly (shown as in the stand of base assembly B) may comprise an actuator (or actuators A shown as electric motors) that may be operated by a control system or manual controls (interacting as required within the mechanism to implement or assist each movement). As schematically indicated in FIGS. 5A-5C, 10A-10F, 13A-13D and 18, an actuator A may operate or assist the recline movement (e.g. X-axis rotation); as indicated schematically in FIGS. 5D-5F, 11A-11F, 13A-13D and 18, an actuator A may operate or assist the swivel movement (e.g. Z-axis rotation); as indicated schematically in FIGS. 5G-5I, 12A-12F, 13A-13D and 18, an actuator A may operate or assist the roll movement (e.g. Y-axis rotation). See also FIGS. 2A-2I. According to an exemplary embodiment, the seating system comprises a mechanism/arrangement that provides for multiple adjustments by movement (e.g. recline/tilt, roll/tilt, rotate/swivel) and that is compact and integrated (e.g. in the base assembly) and configured to provide for a wide variety of combinations of movements and motion freedom/restriction for the seat within a designated range controllable at an interface (e.g. manual controls and/or actuators able to operate independently and/or in combination, etc.). See FIGS. 10A-10B, 11A-11B and 12A-12B. See also FIGS. 2A-2I, 5A-5I, 13A-13D and 18.

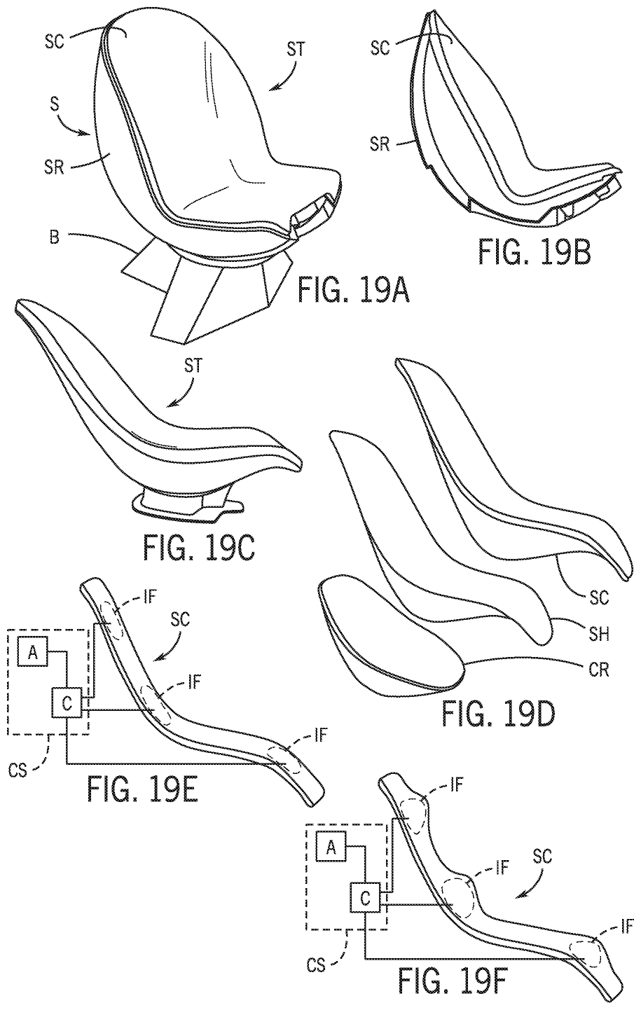

Referring to FIGS. 19A-19D, as shown schematically according an exemplary embodiment the seat assembly ST with base assembly B and seat structure S (of a type shown in FIGS. 1D-1E and 13A) may be provided in a variety of configurations. According to an exemplary embodiment shown in FIGS. 19A-19B, the seat structure S may comprise a frame/shell SR (e.g. one-piece shell/form, multi-segment shell, etc.) providing an exterior structure (e.g. rigid structure/cover) and a seat pad/cushion SC (e.g. liner, foam, inflatable, etc. material with cover) on which the vehicle occupant is physically seated/supported. As indicated schematically according to an exemplary embodiment in FIG. 19D, the seat may comprise a composite (e.g. multi-layer) construction comprising a carrier/platform (e.g. shell) CR and a frame/shell SH (e.g. structure) and a cushion/pad SC (e.g. foam material). As indicated in the FIGURES, any of a wide variety of constructions and configurations of materials used or suitable for vehicle or other seats may be used in the assembly of a seat structure and a seat assembly according to an exemplary embodiment.

As indicated schematically according to an exemplary embodiment in FIGS. 19E-19F, the seat may comprise a cushion or pad/liner shown as pad SC that is adaptable and/or adjustable (e.g. inflatable, fillable, visco-elastic, shape-memory element/material, thermally responsive material, etc.) in whole or in segments such as sections IF; for example, an “adaptive foam” material may be used in the seat construction that may in response to an input or control signal (or manual adjustment) be modified in properties to alter the cushioning/support selectively for the occupant (e.g. providing different support/feel at selective locations on the seat or in different segments of the seat); the seat may comprise a control system CS with an actuator A and control element C used to modify the properties of the seat, for example by selectively activating/energizing or deflating/inflating segments IF of the seat as shown schematically in FIG. 19F (e.g. with actuator A operating as a pump for air and control element C functioning as a valve/port at the direction of a control system CS). According to an exemplary embodiment, the seat assembly may comprise any of a wide variety of components and/or materials, configured and arranged for any of a wide variety of purposes. As indicated schematically, the seat components may comprise conventional materials and/or specialty/engineered materials (e.g. foam, adaptive foam material, engineered plastics/resins, structural materials/fiber, etc.).

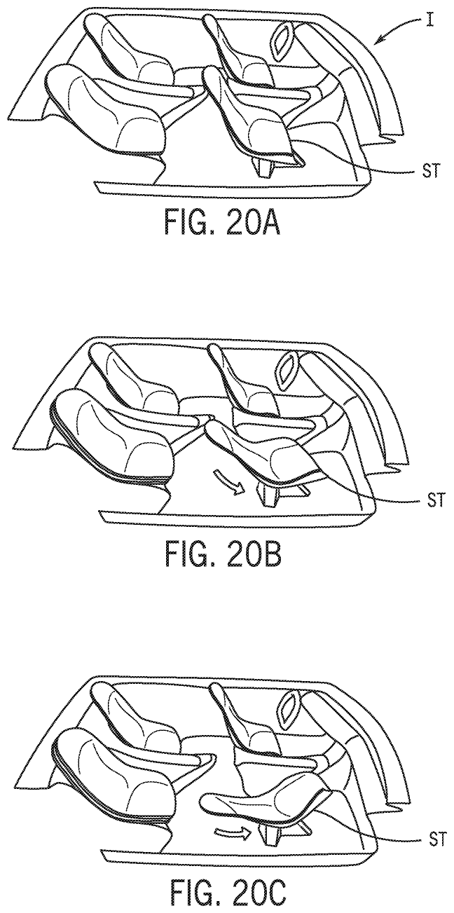

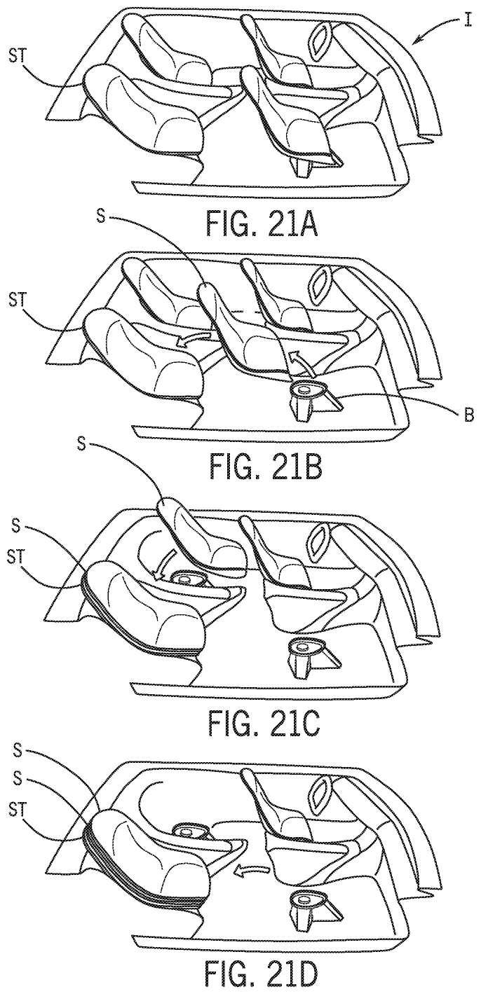

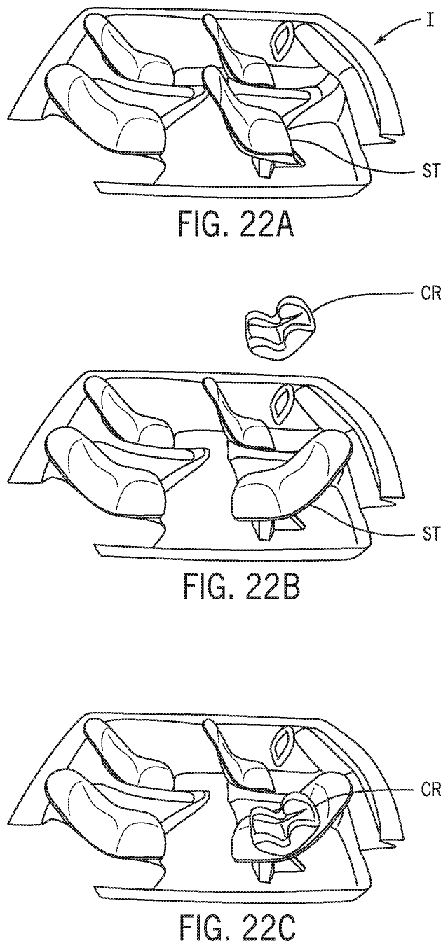

As shown schematically according to an exemplary embodiment in FIGS. 1B-1C, 20A-20C, 21A-21D and 22A-22C, the seating system with seat assemblies may be configured in a variety of arrangements and individual seat orientations; for example, the seating system may be provided in a generally conventional arrangement of seats (see FIGS. 20A, 21A and 22A), with a reclined front passenger seat (see FIGS. 20B-20C), with a seat removed and repositioned (see FIGS. 21B-21D) (removed seat nested in another seat), with a seat configured/oriented for installation of a child safety seat (see FIGS. 22B-22C), etc. As shown according to an exemplary embodiment in FIGS. 21A-21D, seat structures S may be removed and nested (individually or in a group) in a seat assembly ST. It should be understood that according to an exemplary embodiment the seating system may be provided with compliant restraint/attachment arrangements for passengers (driver and occupant), child safety seat, etc.; such arrangements may be provided according to conventional technology or may comprise other/future technology.

### Seating System/Arrangement

According to an exemplary embodiment shown schematically, a seating system for at least one occupant in a vehicle interior may comprise a base assembly configured to be mounted in the vehicle interior and a seat structure configured to be coupled to the base assembly and providing a seat configured for movement relative to the base assembly; movement of the seat relative to the base assembly may comprise at least two of (1) recline movement or (2) swivel movement or (3) tilt movement; recline movement may comprise movement of the seat on a path; swivel movement may comprise rotational movement of the seat; tilt movement may comprise movement of the seat on a path. See for example FIGS. 1A-1E and 2A-2I. Movement of the seat may comprise each of (1) recline movement and (2) swivel movement and (3) tilt movement. See for example FIGS. 2A-2I, 5A-5I, 10A-10D, 11A-11D, 12A-12D and 18. According to an exemplary embodiment, movement of the seat relative to the base may comprise (1) recline movement in rotation about a first axis and (2) swivel movement in rotation about a second axis and (3) tilt movement in rotation about a third axis; axes of movement may share a generally coincident location in space. See for example FIGS. 10A-10D, 11A-11D, 12A-12D and 18.)

According to an exemplary embodiment shown schematically, a seat assembly may be formed from installation of the seat structure on the base assembly at a pivot axis. See for example FIGS. 3A-3D and 9A-9E. See also FIGS. 10A-10F, 11A-11F and 12A-12F. According to an exemplary embodiment shown schematically, the seat structure may be coupled to the base assembly at an interface (e.g. a fixed point, mounting point, fixture point, mounting fixture, etc.); the interface may comprise at least one of (a) a pivot pin; (b) a post; (c) a fastener; (d) a threaded fastener; (e) a bolt with a cap; (f) a post with a cap; (g) a threaded shaft; (h) a bolt threaded into a mounting structure; (i) a post through at least one slot; (j) a post through at least two slots; (k) a fastener to secure the seat structure to the base assembly; (l) a component of a mechanism to facilitate movement of the seat structure relative to the base; (m) a component of a mechanism to retain the seat structure in a track; (n) a component to retain the seat structure by engagement with a latch mechanism; (o) a mounting point; (p) a pivot point; (q) an interface for a mechanism to facilitate movement of the seat relative to the base assembly; (r) a shaft; (s) a mechanism to facilitate movement of the seat. See for example FIGS. 3A-3D, 7A-7B, 9A-9E, 14A-14F, 16A-16F, 17A-17D and 18. The base assembly may comprise a stand. See for example FIGS. 1C-1E, 3C-3D, 9C-9E, 13A and 19A.

According to an exemplary embodiment shown schematically, the base assembly may comprise a mechanism configured to facilitate movement of the seat relative to the base assembly; the mechanism may comprise at least one of (a) a pivot; (b) a post with a cap; (c) a clamp mechanism; (d) a clutch mechanism; (e) a set of plates to engage and disengage for movement of the seat; (f) a slot; (g) a set of slots; (h) a slot and keyway arrangement; (i) an actuator; (j) a motor; (k) a control system; (l) a central joint; (m) a brake; (n) a clamp; (o) a locking mechanism; (p) a manually operated mechanism; (q) a set of mechanisms; (r) a set of actuators; (s) a set of motors; (t) a generally central pivot point at the coupling of the seat structure to the base assembly; (u) a coupling of the seat structure to the base assembly; (v) a mechanism comprising a post; (w) an interface between the seat structure and the base assembly; (x) a mechanism interoperable with a latch mechanism for removal of the seat structure from the base assembly; (y) a mechanism located at the mounting point; (z) a mechanism to facilitate at least two of recline movement and tilt movement and swivel movement. See for example FIGS. 3A-3D, 7A-7B, 9A-9E, 14A-14F, 16A-16F, 17A-17D and 18. According to an exemplary embodiment shown schematically, the set of plates to engage and disengage may comprise at least one plate from the base assembly and a plate from the seat structure; the set of plates may operate as a clamp when engaged and release to seat for movement with reduced friction when disengaged. See for example FIGS. 3A-3D, 7A-7B, 9A-9E, 14A-14F, 16A-16F, 17A-17D. According to an exemplary embodiment shown schematically, the mechanism may provide (1) a disengaged mode wherein the seat structure may be freely movable relative to the base assembly (see for example FIG. 17A); and (2) a partially engaged mode wherein the seat structure may be retained in position but movable relative to the base assembly by application of enhanced force (e.g. to overcome internal friction such as between plates) (see for example FIG. 17B); (3) an engaged mode wherein the seat structure may be clamped in position relative to the base assembly (see for example FIG. 17C).

According to an exemplary embodiment shown schematically, the seat structure may comprise at least one of (a) a shell; (b) an exterior shell; (c) a one-piece molded shell; (d) a carrier; (e) a carrier cup; (f) a carrier for the seat; (g) a generally spherical-shaped shell; (h) a plastic molded shell. The seat may comprise at least one of (a) a cushion; (b) a pad, (c) a foam cushion; (d) a liner; (e) a cover (f) a foam material; (g) an adaptive foam material; (h) a visco-elastic material; (i) an inflatable segment; (j) a fillable segment; (k) a shape-memory material; (l) a one-piece exterior shell. See for example FIGS. 1B-1E and 19A-19F.

According to an exemplary embodiment shown schematically, the seat structure may be removable from the base assembly. See for example FIGS. 2J-2L and 5J-5L. According to an exemplary embodiment shown schematically, the seat structure may be removable by disengagement of a latch mechanism; the latch mechanism may comprise a button and a latch; the mechanism to facilitate movement of the seat relative to the base may comprise a post with a cap; the latch may be configured to engage the cap of the post to retain the seat structure and to disengage the cap of the post to release the seat structure for removal from the base assembly. See for example FIGS. 9A-9E, 13A-13D, 14A-14F, 15A-15D, and 16A-16F. The latch mechanism may provide a stop for recline movement. See for example FIGS. 9A-9E and 10A-10E. The seat structure may be removable by operation of a mechanism to facilitate movement of the seat relative to the base assembly and by disengagement of the latch mechanism retaining the seat structure on the base assembly. See for example FIGS. 14A-14F, 15A-15D, 16A-16F and 17A-17C.

According to an exemplary embodiment shown schematically, movement of the seat relative the base assembly may be at least one of (a) actuated by an actuator of (b) assisted by an actuator; (c) manually operated by an occupant; (d) by body displacement of an occupant; (e) by body position shift of an occupant; (f) autonomous in operation of the vehicle; (g) configured to return the seat to a default position relative to the base assembly when the seat may be empty. See for example FIGS. 3A-3D, 7A-7B, 9A-9E, 10A-10D, 11A-11D, 12A-12D, 14A-14F, 16A-16F and 18. Tilt (e.g. roll) movement may comprise generally translating movement of the seat; the path of tilt movement may be generally transverse to the path of recline movement. See for example FIGS. 12A-12D. Recline movement may comprise generally translating movement of the seat; recline movement may be at least one of (a) guided within a slot; (b) in a forward and rearward direction relative to the seat; (c) curved movement; (d) lifting movement; (e) guided within a longitudinal slot; (f) guided by a post in the slot; (g) along a curved track; (h) in a range of movement asymmetrical relative to the seat. See for example FIGS. 10A-10D. The path of recline movement may be at least one of (a) curved; (b) at least partially curved; (c) about an axis; (d) configured to recline the seat; (e) used to remove the seat structure from the base assembly; (f) constrained by a mechanism; (g) defined by a slot; (h) defined by a track; (i) terminated at a stop; (j) generally transverse to the path of tilt movement. See for example FIGS. 2A-2C, 5A-5C and 10A-10E. Tilt movement may be at least one of (a) guided within a slot; (b) in a lateral direction relative to the seat; (c) curved movement; (d) lifting movement; (e) transverse to recline movement; (f) guided by a post in a slot; (g) along a curved track; (h) in a range of movement symmetrical relative to the seat. See for example FIGS. 2G-2I, 5G-5I and 12A-12E. Swivel movement may be at least one of (a) may be about the pivot; (b) about a central joint; (c) about an axis aligned with the base assembly; (d) about a fixed post; (e) in a range of movement symmetrical to the seat. See for example FIGS. 2D-2F, 5D-5F and 11A-11E.

According to an exemplary embodiment shown schematically, movement may comprise independent movement so that recline movement may occur without at least one of swivel movement and tilt movement. Movement may comprise combined movement so that recline movement may occur simultaneous with at least one of swivel movement and tilt movement. According to an exemplary embodiment shown schematically, movement may comprise independent movement so that (a) tilt movement may occur without at least one of swivel movement and recline movement; (b) swivel movement may occur without at least one of recline movement and tilt movement; (c) recline movement may occur without at least one of swivel movement and tilt movement. According to an exemplary embodiment shown schematically, movement of the seat relative to the base assembly may be actuated by body displacement from the occupant in the seat. See for example FIGS. 10A-10B, 11A-11B and 12A-12B.

According to an exemplary embodiment shown schematically, the seating system may comprise a first seat assembly and a second seat assembly; a seat structure of the first seat assembly may be configured to be removed from the base assembly of the first seat assembly and stacked on a seat structure of the second seat assembly; the seat structure of first seat assembly may be configured to be nested on the seat structure of the second seat assembly. See for example FIGS. 21A-21D. The seat system may comprise at least two seat assemblies (or more). See for example FIGS. 1B-1C and 22A-22C.

According to an exemplary embodiment shown schematically, the seat structure may be coupled to the base assembly at a single mechanism and/or single interface (e.g. a compact stand/base structure). See for example FIGS. 1D-1E, 3A-3D, 9A-9E, 13A and 19A. See also FIGS. 1B-1C, 20A-20C, 21A-21D and 22A-22C. According to an exemplary embodiment shown schematically, the base assembly (e.g. base or base structure) may comprise a structure that can be physically and visually integrated with other features and forms of the vehicle interior. See for example FIGS. 1B-1E, 13A, 19A, 20A-20C, 21A-21D and 22A-22C. According to an exemplary embodiment shown schematically, the base assembly may comprise a structure that can be physically and visually integrated with at least one of (a) door panel; (b) instrument panel; (c) vehicle interior components. See for example FIGS. 1B-1E, 20A-20C, 21A-21D and 22A-22C.

According to an exemplary embodiment shown schematically, a seat assembly for a vehicle interior may comprise a base configured to be mounted in the vehicle interior and a seat structure configured to be coupled to the base and providing a seat configured for movement relative to the base assembly; and a mechanism to couple the seat structure to the base; movement of the seat relative to the base may comprise at least recline movement; recline movement may comprise movement of the seat on a path defined by the mechanism. See for example FIGS. 1B-1E and 2A-2I. See also FIGS. 3A-3D, 5A-5I and 19A. According to an exemplary embodiment shown schematically, the mechanism may comprise at least one of (a) a mechanism to facilitate movement of the seat relative to the base; (b) a slot providing the path; (c) a clamp mechanism; (d) a clutch-plate mechanism; (e) a set of plates configured to be engaged and disengaged. See for example FIGS. 1B-1E, 3A-3D, 7A-7B, 9A-9E, 14A-14F, 16A-16F, 17A-17D and 18. Movement of the seat relative to the base assembly may comprise tilt movement and swivel movement. See for example FIGS. 2A-2I, 5A-5I, 10A-10D, 11A-11D, 12A-12D and 18. According to an exemplary embodiment shown schematically, the seat assembly may comprise a latch mechanism to facilitate removal of the seat structure from the base. See for example FIGS. 2J-2L, 5J-5L, 9A-9E, 13A-13D, 14A-14F, 15A-15D, and 16A-16F.

According to an exemplary embodiment shown schematically, a seat assembly for at least one occupant in a vehicle interior may comprise a base configured to be mounted in the vehicle interior and a seat configured to be coupled to the base and configured for movement relative to the base with a mechanism providing an interface to couple the seat to the base and a mechanism to facilitate removal of the seat from the base; movement of the seat relative to the base may comprise at least two of (1) recline movement or (2) swivel movement or (3) tilt movement; recline movement may comprise movement of the seat on a path; swivel movement may comprise rotational movement of the seat; tilt movement may comprise movement of the seat on a path. See for example FIGS. 1B-1E, 2A-2I, 3A-3D, 5A-5I, 7A-7B, 9A-9E, 10A-10D, 11A-11D, 12A-12D, 14A-14F, 16A-16F, 17A-17D and 18. Movement of the seat relative to the base assembly may comprise tilt movement and swivel movement. See for example FIGS. 2A-2I, 5A-5I, 10A-10D, 11A-11D, 12A-12D and 18. According to an exemplary embodiment shown schematically, the interface may comprise a shaft (e.g. a generally central mounting structure). See for example FIGS. 3A-3D, 9A-9E, 13A-13D and 18. According to an exemplary embodiment shown schematically, the seat may comprise a shell structure (e.g. a formed component integrated with and/or mounted on a substrate/platform of the seat structure). See for example FIGS. 1C-1E, 13A, and 19A-19D.

According to an exemplary embodiment shown schematically, a seat assembly for a vehicle interior may comprise a base configured to be mounted in the vehicle interior and a seat structure configured to be coupled to the base and providing a seat configured for movement relative to the base assembly and a mechanism configured to couple the seat structure to the base; the mechanism is configured to define a path of movement of the seat relative to the base. See for example FIGS. 1B-1E, 2A-2I, 3A-3D, 5A-5I, 7A-7B, 9A-9E, 10A-10D, 11A-11D, 12A-12D, 14A-14F, 16A-16F, 17A-17D and 18. According to an exemplary embodiment shown schematically, the mechanism may comprise at least one of (a) a mechanism to facilitate movement of the seat relative to the base; (b) a slot providing the path; (c) a clamp mechanism; (d) a clutch-plate mechanism; (e) a set of plates configured to be engaged to retain the seat in position with the base and disengaged for movement of the seat relative to the base; (f) at least one actuator; (g) a pivot shaft with a cap; (h) a pivot post. See for example FIGS. 2A-2I, 3A-3D, 5A-5I, 9A-9E, 10A-10D, 11A-11D, 12A-12D, 13A-13D and 18. Movement of the seat relative to the base may comprise at least one of (1) recline movement and (2) swivel movement and (3) tilt movement. See for example FIGS. 2A-2I, 3A-3D, and 5A-5I.

According to an exemplary embodiment shown schematically, a seat assembly for a vehicle interior comprising a base configured to be mounted in the vehicle interior and a seat structure configured to be coupled to the base and providing a seat configured for movement relative to the base assembly and a mechanism configured to couple the seat structure to the base; the mechanism is configured to provide a path of movement of the seat relative to the base; movement of the seat relative to the base may comprise at least one of (1) recline movement and (2) swivel movement and (3) tilt movement. See for example FIGS. 1B-1E, 2A-2I, 3A-3D, 5A-5I and 19A. According to an exemplary embodiment shown schematically, the mechanism may comprise at least one of (a) a mechanism to facilitate movement of the seat relative to the base; (b) a slot providing the path; (c) a clamp mechanism; (d) a clutch-plate mechanism; (e) a set of plates configured to be engaged to retain the seat in position with the base and disengaged for movement of the seat relative to the base; (f) at least one actuator; (g) a post for swivel movement; (h) a slot for recline movement and a slot for tilt movement generally transverse to the slot for recline movement. See for example FIGS. 2A-2I, 3A-3D, 5A-5I, 9A-9E, 10A-10D, 11A-11D, 12A-12D, 13A-13D and 18.

### Exemplary Embodiments

According to an exemplary embodiment, vehicle V may comprise an adjustable seat arrangement; as indicated the seat arrangement may comprise seats in a configuration in a vehicle interior with features that are complementary and useful for a wide variety of types of vehicles (and/or that are capable of implementation in a manner useful/unique to autonomous vehicles).

According to an exemplary embodiment, the seats (e.g. one seat or each seat including the driver seat) in the vehicle interior may be detached, attached, re-oriented, adjusted in use by occupants, etc. See FIGS. 1A and 1B. See also FIGS. 3A-3D, 4A-4L and 5A-5L. As indicated schematically in the FIGURES, according to an exemplary embodiment a vehicle seat may be provided with multiple types of adjustability (e.g. rotate, tilt, translate, roll, swivel, shift, lift/lower, etc. as to give a wide variety of positions/positioning such as may be felt by a passenger-occupant as “floating” in the interior of the vehicle). As indicated according to an exemplary embodiment, the vehicle seat may be combined with various other known/conventional seat control/comfort systems (e.g. automated adjustment mechanisms, slide at base/relative to vehicle floor, raise/lower height, relative to vehicle floor, tilt/recline, heating/cooling, etc.).

According to an exemplary embodiment as shown schematically in FIGS. 1A-1C, in a vehicle such as an autonomous (autonomously driven) vehicle it may be appropriate (at times where permitted/proper) to re-orient the seating arrangement (e.g. position and orientation of vehicle seats) including in proper circumstances the so-called “driver seat”; in an autonomous vehicle the mode of operating the vehicle may permit various movements and positioning and orientation/re-orientation of one seat and/or multiple seats to facilitate purposes such as occupant interaction/activity and comfort/rest as well as driver attention/comfort, etc.

According to an exemplary embodiment, a seat for vehicle interior is intended to be attached to a seat support shown as a shell. See FIGS. 1B-1C and D-1E (showing entire seat assembly with seat/seat structure on seat support and installed on base assembly as in use/operation in vehicle).

According to an exemplary embodiment as shown schematically, seat support 100 is attached to base assembly 200 at a slot or track 130s to form seat system 300; slot 130s is configured to facilitate movement of seat support 100 in the fore/aft direction and rotation of seat support 100 about fastener 210. See FIGS. 3A-3D.

According to an exemplary embodiment as shown schematically, seat support 100 is configured to slide along slot or track 130s to facilitate movement of seat support 100 in the fore/aft direction (e.g. recline movement). See FIGS. 4A-4C and 5A-5C.

According to an exemplary embodiment as shown schematically, seat support 100 is configured to rotate around fastener 210 to facilitate swivel of seat support 100 (e.g. swivel/rotation movement). See FIGS. 4D-4F and 5D-5F.

According to an exemplary embodiment as shown schematically, seat support 100 is configured to roll/slide along slot or track 230s to facilitate side to side movement of seat support 100 (e.g. roll/tilt movement). See FIGS. 4G-4I and 5G-5I, 6A and 6C.

As shown schematically in FIGS. 4J-4L, seat support 100 can be detached from base assembly 200 by sliding seat support 100 rearward. See also FIGS. 5J-5L. As shown schematically in FIGS. 4J to 4L according to an exemplary embodiment, seat support 100 can be detached from base assembly 200 by sliding seat support 100 rearward.

As shown schematically in FIGS. 4J-4L, seat support 100 can be detached from base assembly 200 by sliding seat support 100 rearward.

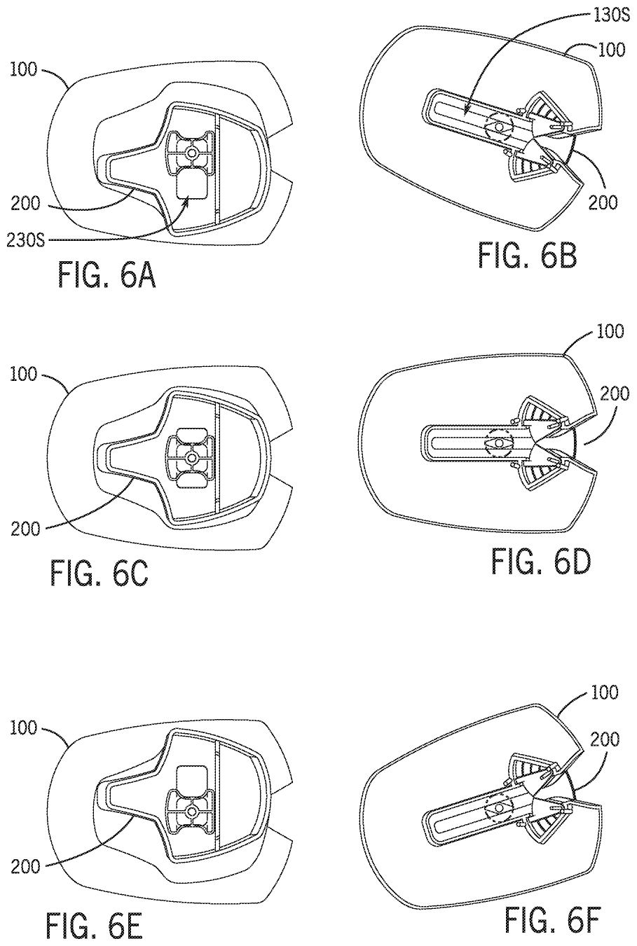

As shown schematically in FIGS. 3B-3D, fastener 210 and mounting plate 240 are configured to secure plate 220 onto base 230 and facilitate side to side movement of plate 220 along track 230s. See also FIGS. 6A-6F.

As shown schematically in FIGS. 3B and 6B, feature 222 is generally diamond shaped (i.e. rhombus). One of the diagonal of feature 222 corresponds to the width of the inner section of slot/track 130s; feature 222 is intended to provide stability and define the range of swivel of seat support 100 relative to base assembly 200.

As shown schematically in FIGS. 3B, 7B-7C and 8A-8D, fastener 210 provides a portion shown as a cap and a portion shown as a post providing thread. The diameter of the cap generally corresponds to the width of the outer section of track 130s. Cap is intended to provide stability for seat support 100.

As shown schematically according to an exemplary embodiment in FIGS. 1B-1E, seat support 100 may be attached to base assembly 200 to form seat system 300.

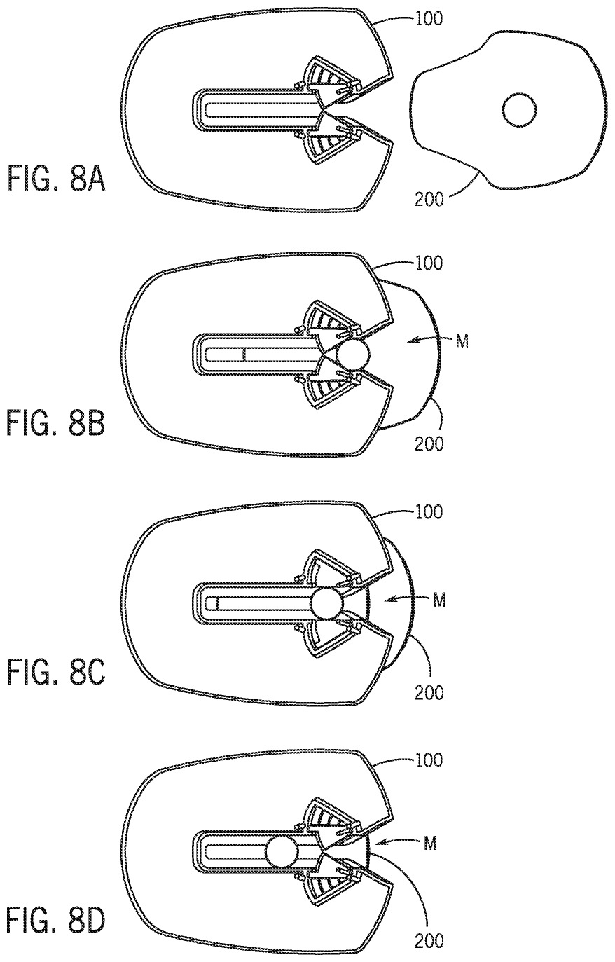

As shown schematically in FIGS. 3A-3D and 8A-8D, seat support 100 may be attached to base assembly 200 via slot/track 130s.

As shown schematically in FIG. 8C, tabs 120 are intended be retractable; tabs 120 are configured to be at a retracted position to allow the cap of fastener 210 to enter/exit the slot or track 130s.

As shown schematically in FIG. 8D, tabs 120 are configured to be at an extended position to retain the cap of fastener 210.

It is important to note that the construction and arrangement of the elements of the inventive concepts and inventions as described in this application and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the apparatus of the present inventions can comprise conventional technology (e.g. as implemented in present configuration) or any other applicable technology (present or future) that has the capability to perform the functions and processes/operations indicated in the FIGURES. All such technology is considered to be within the scope of the present inventions and application.

1. A seating system for at least one occupant in a vehicle interior comprising:
(a) a base assembly configured to be mounted in the vehicle interior;
(b) a seat structure configured to be coupled to the base assembly and providing a seat configured for movement relative to the base assembly;
wherein movement of the seat relative to the base assembly comprises at least two of (1) recline movement or (2) swivel movement or (3) tilt movement;
wherein recline movement comprises movement of the seat on a path;
wherein swivel movement comprises rotational movement of the seat;
wherein tilt movement comprises movement of the seat on a path.

2. The seating system of claim 1 wherein movement of the seat relative to the base assembly comprises each of (1) recline movement and (2) swivel movement and (3) tilt movement.

3. The seating system of claim 1 wherein movement of the seat relative to the base assembly comprises (1) recline movement in rotation about a first axis and (2) swivel movement in rotation about a second axis and (3) tilt movement in rotation about a third axis.

4. The seating system of claim 1 wherein a seat assembly is formed from installation of the seat structure on the base assembly at a pivot axis.

5. The seating system of claim 1 wherein the seat structure is coupled to the base assembly at an interface.

6. The seating system of claim 5 wherein the interface comprises at least one of (a) a pivot pin; (b) a post; (c) a fastener; (d) a threaded fastener; (e) a bolt with a cap; (f) a post with a cap; (g) a threaded shaft; (h) a bolt threaded into a mounting structure; (i) a post through at least one slot; (j) a post through at least two slots; (k) a fastener to secure the seat structure to the base assembly; (l) a component of a mechanism to facilitate movement of the seat structure relative to the base; (m) a component of a mechanism to retain the seat structure in a track; (n) a component to retain the seat structure by engagement with a latch mechanism; (o) a mounting point; (p) a pivot point; (q) an interface for a mechanism to facilitate movement of the seat relative to the base assembly; (r) a shaft; (s) a mechanism to facilitate movement of the seat.

7. The seating system of claim 1 wherein the base assembly comprises a stand.

8. The seating system of claim 1 wherein the base assembly comprises a mechanism configured to facilitate movement of the seat relative to the base assembly.

9. The seating system of claim 8 wherein the mechanism comprises at least one of (a) a pivot; (b) a post with a cap; (c) a clamp mechanism; (d) a clutch mechanism; (e) a set of plates to engage and disengage for movement of the seat; (f) a slot; (g) a set of slots; (h) a slot and keyway arrangement; (i) an actuator; (j) a motor; (k) a control system; (l) a central joint; (m) a brake; (n) a clamp; (o) a locking mechanism; (p) a manually operated mechanism; (q) a set of mechanisms; (r) a set of actuators; (s) a set of motors; (t) a generally central pivot point at the coupling of the seat structure to the base assembly; (u) a coupling of the seat structure to the base assembly; (v) a mechanism comprising a post; (w) an interface between the seat structure and the base assembly; (x) a mechanism interoperable with a latch mechanism for removal of the seat structure from the base assembly; (y) a mechanism located at the mounting point; (z) a mechanism to facilitate at least two of recline movement and tilt movement and swivel movement.

10. The seating system of claim 9 wherein the set of plates to engage and disengage comprises at least one plate from the base assembly and a plate from the seat structure.

11. The seating system of claim 10 wherein the set of plates operate as a clamp when engaged and release to seat for movement with reduced friction when disengaged.

12. The seating system of claim 8 wherein the mechanism provides (1) a disengaged mode wherein the seat structure is freely movable relative to the base assembly; and (2) a partially engaged mode wherein the seat structure is retained in position but movable relative to the base assembly by application of enhanced force; (3) an engaged mode wherein the seat structure is clamped in position relative to the base assembly.

13. The seating system of claim 1 wherein the seat structure comprises at least one of (a) a shell; (b) an exterior shell; (c) a one-piece molded shell; (d) a carrier; (e) a carrier cup; (f) a carrier for the seat; (g) a generally spherical-shaped shell; (h) a plastic molded shell; (i) a one-piece exterior shell.

14. The seating system of claim 1 wherein the seat comprises at least one of (a) a cushion; (b) a pad, (c) a foam cushion; (d) a liner; (e) a cover (f) a foam material; (g) an adaptive foam material; (h) a visco-elastic material; (i) an inflatable segment; (j) a fillable segment; (k) a shape-memory material.

15. The seating system of claim 1 wherein the seat structure is removable from the base assembly.

16. The seating system of claim 15 wherein the seat structure is removable by disengagement of a latch mechanism.

17. The seating system of claim 16 wherein the seat structure is removable by operation of a mechanism to facilitate movement of the seat relative to the base assembly and by disengagement of the latch mechanism retaining the seat structure on the base assembly.

18. The seating system of claim 17 wherein the latch mechanism comprises a button and a latch; wherein the mechanism to facilitate movement of the seat relative to the base comprises a post with a cap; wherein the latch is configured to engage the cap of the post to retain the seat structure and to disengage the cap of the post to release the seat structure for removal from the base assembly.

19. The seating system of claim 15 wherein the latch mechanism provides a stop for recline movement.

20. The seating system of claim 1 wherein movement of the seat relative the base assembly is at least one of (a) actuated by an actuator of (b) assisted by an actuator; (c) manually operated by an occupant; (d) by body displacement of an occupant; (e) by body position shift of an occupant; (f) autonomous in operation of the vehicle; (g) configured to return the seat to a default position relative to the base assembly when the seat is empty.

21. The seating system of claim 1 wherein recline movement comprises generally translating movement of the seat.

22. The seating system of claim 1 wherein tilt movement comprises generally translating movement of the seat.

23. The seating system of claim 1 wherein the path of tilt movement is generally transverse to the path of recline movement.

24. The seating system of claim 1 wherein recline movement is at least one of (a) guided within a slot; (b) in a forward and rearward direction relative to the seat; (c) curved movement; (d) lifting movement; (e) guided within a longitudinal slot; (f) guided by a post in the slot; (g) along a curved track; (h) in a range of movement asymmetrical relative to the seat.

25. The seating system of claim 1 wherein the path of recline movement is at least one of (a) curved; (b) at least partially curved; (c) about an axis; (d) configured to recline the seat; (e) used to remove the seat structure from the base assembly; (f) constrained by a mechanism; (g) defined by a slot; (h) defined by a track; (i) terminated at a stop; (j) generally transverse to the path of tilt movement.

26. The seating system of claim 1 wherein tilt movement is at least one of (a) guided within a slot; (b) in a lateral direction relative to the seat; (c) curved movement; (d) lifting movement; (e) transverse to recline movement; (f) guided by a post in a slot; (g) along a curved track; (h) in a range of movement symmetrical relative to the seat.

27. The seating system of claim 1 wherein swivel movement is at least one of (a) about the pivot; (b) about a central joint; (c) about an axis aligned with the base assembly; (d) about a fixed post; (e) in a range of movement symmetrical to the seat.

28. The seating system of claim 1 wherein movement of the seat relative to the base comprises independent movement so that recline movement may occur without at least one of swivel movement and tilt movement.

29. The seating system of claim 1 wherein movement of the seat relative to the base comprises combined movement so that recline movement may occur simultaneous with at least one of swivel movement and tilt movement.

30. The seating system of claim 1 wherein movement of the seat relative to the base comprises independent movement so that (a) tilt movement may occur without at least one of swivel movement and recline movement; (b) swivel movement may occur without at least one of recline movement and tilt movement; (c) recline movement may occur without at least one of swivel movement and tilt movement.

31. The seating system of claim 1 wherein movement of the seat relative to the base assembly is actuated by body displacement from the occupant in the seat.

32. The seating system of claim 1 comprising a first seat assembly and a second seat assembly; wherein a seat structure of the first seat assembly is configured to be removed from the base assembly of the first seat assembly and stacked on a seat structure of the second seat assembly.

33. The seating system of claim 32 wherein the seat structure of first seat assembly is configured to be nested on the seat structure of the second seat assembly.

34. The seating system of claim 1 further comprising at least two seat assemblies.

35. The seating system of claim 1 wherein the seat structure is coupled to the base assembly at a single mechanism.

36. The seating system of claim 1 wherein the base assembly comprises a structure that can be physically and visually integrated with other features and forms of the vehicle interior; wherein other features and forms of the vehicle interior comprise at least one of (a) door panel; (b) instrument panel; (c) vehicle interior components.

37. A seat assembly for a vehicle interior comprising:
(a) a base configured to be mounted in the vehicle interior;
(b) a seat structure configured to be coupled to the base and providing a seat configured for movement relative to the base assembly;
(c) a mechanism configured to couple the seat structure to the base;
wherein movement of the seat relative to the base comprises at least recline movement;
wherein recline movement comprises movement of the seat on a path defined by the mechanism;
wherein the mechanism comprises at least one of (a) a mechanism to facilitate movement of the seat relative to the base; (b) a slot providing the path; (c) a clamp mechanism; (d) a clutch-plate mechanism; (e) a set of plates configured to be engaged and disengaged.

38. The seat assembly of claim 37 wherein movement of the seat relative to the base assembly comprises tilt movement and swivel movement.

39. The seat assembly of claim 37 further comprising a latch mechanism to facilitate removal of the seat structure from the base.

40. A seat assembly for at least one occupant in a vehicle interior comprising:
(a) a base configured to be mounted in the vehicle interior;
(b) a seat configured to be coupled to the base and configured for movement relative to the base;
(c) a mechanism providing an interface to couple the seat to the base;
(d) a mechanism to facilitate removal of the seat from the base;
wherein movement of the seat relative to the base comprises at least two of (1) recline movement or (2) swivel movement or (3) tilt movement;
wherein recline movement comprises movement of the seat on a path;
wherein swivel movement comprises rotational movement of the seat;
wherein tilt movement comprises movement of the seat on a path.

41. The seat assembly of claim 40 wherein the interface comprises a shaft.

42. The seat assembly of claim 40 wherein the seat comprises a shell structure.

43. A seat assembly for a vehicle interior comprising:
(a) a base configured to be mounted in the vehicle interior;
(b) a seat structure configured to be coupled to the base and providing a seat configured for movement relative to the base assembly;
(c) a mechanism configured to couple the seat structure to the base;
wherein the mechanism is configured to define a path of movement of the seat relative to the base.

44. The seat assembly of claim 43 wherein the mechanism comprises at least one of (a) a mechanism to facilitate movement of the seat relative to the base; (b) a slot providing the path; (c) a clamp mechanism; (d) a clutch-plate mechanism; (e) a set of plates configured to be engaged to retain the seat in position with the base and disengaged for movement of the seat relative to the base; (f) at least one actuator; (g) a pivot shaft with a cap; (h) a pivot post.

45. The seating system of claim 43 wherein movement of the seat relative to the base comprises at least one of (1) recline movement and (2) swivel movement and (3) tilt movement.

46. A seat assembly for a vehicle interior comprising:
(d) a base configured to be mounted in the vehicle interior;
(e) a seat structure configured to be coupled to the base and providing a seat configured for movement relative to the base assembly;
a mechanism configured to couple the seat structure to the base;
wherein the mechanism is configured to provide a path of movement of the seat relative to the base;
wherein movement of the seat relative to the base comprises at least one of (1) recline movement and (2) swivel movement and (3) tilt movement.

47. The seat assembly of claim 46 wherein the mechanism comprises at least one of (a) a mechanism to facilitate movement of the seat relative to the base; (b) a slot providing the path; (c) a clamp mechanism; (d) a clutch-plate mechanism; (e) a set of plates configured to be engaged to retain the seat in position with the base and disengaged for movement of the seat relative to the base; (f) at least one actuator; (g) a post for swivel movement; (h) a slot for recline movement and a slot for tilt movement generally transverse to the slot for recline movement.
